(19) United States
(12) Patent Application Publication
(10) Pub. No.: US 2026/0278561 A1
(43) Pub. Date: Sep. 17, 2026

(54) AIRCRAFT RECORDS MANAGEMENT PLATFORM

(71) Applicant: Nicole Dyehouse, Cincinnati, OH (US)

(72) Inventor: Nicole Dyehouse, Cincinnati, OH (US)

(21) Appl. No.: 19/166,835

(22) PCT Filed: Mar. 22, 2024
(86) PCT No.: PCT/US2024/021216

§ 371 Date: Sep. 18, 2025

Related U.S. Application Data
(60) Provisional application No. 63/491,653, filed on Mar. 22, 2023.

(51) Int. Cl. G06Q 10/20; B64F 5/60; G06Q 10/0631; G06Q 30/0283

(52) U.S. Cl. CPC G06Q 10/20; B64F 5/60; G06Q 10/063112; G06Q 10/06312; G06Q 30/0284

(57) ABSTRACT

A method is provided for managing compliance of an aircraft. The method includes receiving aircraft records data for a set of aircraft records of the aircraft, and receiving a request for a report providing compliance information for the aircraft. The method includes determining a set of maintenance task requirements for the aircraft, and identifying aircraft records entries that are to be used as compliance values for respective maintenance task requirements. The aircraft records entries are identified by using search keys to search the aircraft records to identify the aircraft records entries that are relevant to compliance with the respective maintenance task requirements. The method includes determining, using one or more compliance rules, whether the aircraft complies with the respective maintenance task requirements, and generating the report providing the compliance information for the aircraft. The method includes causing the report to be accessible via a user interface of an application.

WO

### FIELD OF THE INVENTION

The present invention relates generally to systems and methods for managing aircraft records, and more specifically, to systems and methods for managing aircraft compliance records and related documentation.

### BACKGROUND

Aircraft maintenance is a crucial part of the aviation industry, and is essential for ensuring the safety and airworthiness of an aircraft. The Federal Aviation Administration (FAA) requires that aircraft owners and operators maintain a detailed record of all maintenance and repair work performed on the aircraft, including all parts that have been repaired or replaced.

These records are used to demonstrate compliance with safety regulations, ensure the airworthiness of the aircraft, and establish the service history of the aircraft.

Aircraft recordkeeping involves keeping records of detailed maintenance logs, airworthiness directives (ADs), service bulletins (SBs), parts lists, records of repairs, and more. However, it can be difficult for an owner or operator to accurately maintain aircraft records. For example, aircraft records can be voluminous, while requiring meticulous attention to detail to ensure accuracy and completeness. Additionally, aircraft records are collected over the operational lifespan of the aircraft, which can extend several decades. This creates a large paper trail that can be difficult to follow. Furthermore, some aircraft records are created by hand, while other are electronic records. Still further, aircraft records are subject to strict regulatory maintenance requirements, with penalties being imposed should the aircraft fall out of compliance with these requirements. Moreover, maintenance requirements change over time, and aircraft owners must comply with the most recent version of each respective maintenance requirements. Consequently, processes for reviewing whether an aircraft is compliant are extensive and time consuming. For example, it can take a technician up to six weeks to perform aircraft records research to ensure that the aircraft is compliant with the appropriate regulatory maintenance requirements.

Aircraft owners often hire an operator (e.g., a management company) to assist in operational support of the aircraft. Operational support involves a number of different responsibilities, including assisting in managing aircraft records and ensuring that the aircraft remains compliant with regulatory maintenance requirements. When an owner of an aircraft selects a management company, or wants to change to a new management company, an extensive onboarding or transition process is followed. For example, when a new management company is brought in, a review is performed by the management company to ensure the aircraft is safe to operate. If, for example, a review of aircraft records concludes that the aircrafts records are insufficient to comply with one or more onboarding maintenance requirements, then these maintenance requirements, which often require inspection of the aircraft, may have to be reperformed so that an adequate paper trail is created. This delay can cause complications in situations where, for example, the aircraft owner is trying to sell the aircraft to another individual or organization.

It is an object of the invention to mitigate or overcome some or all of the problems described above.

### SUMMARY OF THE INVENTION

In an aspect of the invention, a method for managing compliance of an aircraft with a set of maintenance task requirements is disclosed. The method includes receiving, by a server device, aircraft records data for a set of aircraft records of the aircraft. The method further includes receiving, by the server device, a request for a report providing compliance information for the aircraft, the request including identification information for the aircraft. The method further includes determining, by the server device, the set of maintenance task requirements for the aircraft by using the identification information for the aircraft to search a data structure that associates identification information for respective aircraft included in a group of aircraft with sets of maintenance task requirements for the respective aircraft in the group. The method further includes identifying, by the server device, aircraft records entries, of the set of aircraft records, that are to be used as compliance values for respective maintenance task requirements included in the set of maintenance task requirements, wherein the aircraft records entries are identified by using search keys to search the aircraft records to identify the aircraft records entries that are relevant to compliance with the respective maintenance task requirements. The method further includes determining, by the server device, whether the aircraft complies with the respective maintenance task requirements, wherein compliance is determined based on whether the compliance values satisfy one or more compliance rules. The method further includes generating, by the server device, the report providing the compliance information for the aircraft, where the compliance information indicates whether the aircraft complies with the respective maintenance requirements. The method further includes causing, by the server device, the report to be accessible via a user interface of an application used to manage the compliance of the aircraft with the set of maintenance task requirements.

In an embodiment of the invention, the method further includes indexing the aircraft records entries such that respective aircraft records entries are associated with one or more spatial positioning values that identify one or more corresponding locations within the respective aircraft records. The method further includes associating maintenance task identifiers included in the maintenance task requirements with aircraft records entries that have been indexed. The method further includes generating, for an aircraft records entry, of the aircraft records entries, a link to a location of the aircraft records entry within a particular aircraft record. In this embodiment, generating the report includes generating the report to include the link such that compliance with a maintenance task requirement corresponding to the aircraft records entry is verifiable by a user.

In another embodiment of the invention, the method further includes receiving instructions from a user device to update the user interface to display the location of the aircraft records entry within the particular aircraft record. The method further includes causing the user interface to display the particular aircraft record such that the location of the aircraft records entry is annotated on the user interface.

In another embodiment of the invention, the method further includes identifying, prior to indexing the aircraft records entries, keywords relevant to compliance with the maintenance task requirements. In this embodiment, indexing the aircraft records entries includes indexing only a portion of the aircraft records entries that correspond to the identified keywords.

In another embodiment of the invention, the keywords used to search the aircraft records include one or more of a keyword corresponding to a maintenance task code, or a keyword corresponding to a set of maintenance task description values.

In another embodiment of the invention, the search keys used to identify the aircraft records entries that are to be used as the compliance values include one or more of: a set of maintenance task identifiers, or a set of maintenance task description values.

In another embodiment of the invention, the method further includes generating, using a data model that has been trained using machine learning, a predicted service limit or failure rate of a component of the aircraft, wherein the prediction is generated by providing the aircraft records data as input to the data model to cause the data model to output the prediction. The method further includes generating a recommended action to perform based on the prediction. When generating the report, the method includes generating the report in a manner that includes the prediction and the recommendation.

In another embodiment of the invention, the recommended action includes one or more of a recommendation to increase a frequency at which a maintenance task is performed.

In another embodiment of the invention, a recommendation to schedule performance of the maintenance task within a designated time frame, or a recommendation to replace the component within a designated time frame.

In another embodiment of the invention, the method further includes generating, using a data model that has been trained using machine learning, an estimated time to complete a maintenance task. The prediction is generated by providing the aircraft records data as input to the data model to cause the data model to output the prediction. The method further includes generating a recommended action to perform based on the prediction. When generating the report, the method includes generating the report in a manner that includes the prediction and the recommendation.

In another embodiment of the invention, the recommended action includes one or more of a recommendation identifying a service provider to use for performing a maintenance task, a recommendation identifying a preferred maintenance facility to use when performing the maintenance task, or a recommended adjustment to a flight schedule to accommodate the estimated time to complete the maintenance task.

In another embodiment of the invention, the method further includes generating, using a data model that has been trained using machine learning, an expected maintenance cost for performing a maintenance task, wherein the prediction is generated by providing the aircraft records data as input to the data model to cause the data model to output the prediction. The method further includes generating a recommended action to perform based on the prediction. In this embodiment, generating the report includes generating the report in a manner that includes the prediction and the recommendation.

In another embodiment of the invention, the recommended action includes one or more of a recommendation identifying a preferred service provider, or a recommendation identifying a preferred maintenance facility to use when performing the maintenance task.

In another embodiment of the invention, generating the report includes generating, on a first portion of the report, data identifying a compliance status with one or more maintenance task requirements of the set of maintenance task requirements. The method further including generating, on a second portion of the report, plan data identifying a compliance plan that includes information identifying actions to perform to remain in compliance with the one or more maintenance task requirements.

In another embodiment of the invention, the method further comprises generating, on a first portion of the report, error identification information that identifies one or more recording errors found in the aircraft records data. The method further comprises generating, on a second portion of the report, information that identifies one or more corrective actions to correct the one or more identified recording errors.

In another embodiment of the invention, generating the report includes generating a summary page of the report that includes summary information that summarizes one or more maintenance task requirements, of the set of maintenance task requirements, and other summary information that summarizes compliance with the one or more maintenance task requirements.

In another aspect of the invention, a device is provided. The device includes one or more memories and one or more processors, communicatively coupled to the one or more memories. The one or more processors are to receive aircraft records data for a set of aircraft records of the aircraft. The one or more processors are further to receive a request for a report providing compliance information for the aircraft. The request includes identification information for the aircraft. The one or more processors are further to determine the set of maintenance task requirements for the aircraft by using the identification information for the aircraft to search a data structure that associates identification information for respective aircraft included in a group of aircraft with sets of maintenance task requirements for the respective aircraft in the group. The one or more processors are further to identify aircraft records entries, of the set of aircraft records, that are to be used as compliance values for respective maintenance task requirements included in the set of maintenance task requirements. The aircraft records entries are identified by using search keys to search the aircraft records to identify the aircraft records entries that are relevant to compliance with the respective maintenance task requirements. The one or more processors are further to determine whether the aircraft complies with the respective maintenance task requirements, wherein compliance is determined based on whether the compliance values satisfy one or more compliance rules. The one or more processors are further to generate the report providing the compliance information for the aircraft. The compliance information indicates whether the aircraft complies with the respective maintenance requirements. The one or more processors are further to cause the report to be accessible via a user interface of an application used to manage the compliance of the aircraft with the set of maintenance task requirements.

In another aspect of the invention, a non-transitory computer-readable medium is provided. The non-transitory computer-readable medium stores instructions, including one or more instructions that, when executed by one or more processors, cause the one or more processors to receive aircraft records data for a set of aircraft records of the aircraft. The one or more instructions further cause the one or more processors to receive a request for a report providing compliance information for the aircraft, the request including identification information for the aircraft. The one or more instructions further cause the one or more processors to determine the set of maintenance task requirements for the aircraft by using the identification information for the aircraft to search a data structure that associates identification information for respective aircraft included in a group of aircraft with sets of maintenance task requirements for the respective aircraft in the group. The one or more instructions further cause the one or more processors to identify aircraft records entries, of the set of aircraft records, that are to be used as compliance values for respective maintenance task requirements included in the set of maintenance task requirements. The aircraft records entries are identified by using search keys to search the aircraft records to identify the aircraft records entries that are relevant to compliance with the respective maintenance task requirements. The one or more instructions further cause the one or more processors to determine whether the aircraft complies with the respective maintenance task requirements, wherein compliance is determined based on whether the compliance values satisfy one or more compliance rules. The one or more instructions further cause the one or more processors to generate the report providing the compliance information for the aircraft, where the compliance information indicates whether the aircraft complies with the respective maintenance requirements. The one or more instructions further cause the one or more processors to cause the report to be accessible via a user interface of an application used to manage the compliance of the aircraft with the set of maintenance task requirements.

In this way, the server device provides a report that includes content and/or features that ensure the user remains compliant with maintenance task requirements. Furthermore, existing data storage systems are inefficient and/or ineffective in the utilization of resources (e.g., processing resources, memory resources, network resources, etc.) used to manage aircraft records. For example, online storage tracking systems (e.g., CAMP, AvTraxx, etc.) often store a large quantity of erroneous data. Incorrect compliance status information is especially problematic, as it may give a user the false impression that he or she is in compliance, when in reality, he or she is not. This can lead to prolonged periods where the user is not in compliance. Furthermore, this wastes network and storage resources, as the erroneous data eventually needs to be replaced by correct data. Relative to these systems, the server device is more accurate, more efficient in the utilization of resources, and able to seamlessly identify and correct any incorrect or missing information found in the user's aircraft records.

All possible combinations of aspects and/or embodiments, which are described above and/or herein, are contemplated. The objects and advantages of the present invention shall be made further apparent from the accompanying drawings and the description thereof.

### BRIEF DESCRIPTION OF THE DRAWINGS

FIG. 1A is a diagram of a records management platform obtaining maintenance requirements data for a collection of aircraft.

FIG. 1B is a diagram of the records management platform obtaining aircraft records data for an aircraft.

FIG. 1C is a diagram of a user requesting a compliance report from the records management platform.

FIG. 1D is a diagram of the records management platform determining a list of maintenance task requirements for the aircraft of the user.

FIG. 1E is a diagram of the records management platform generating an index of aircraft records entries.

FIG. 1F is a diagram of the records management platform associating task codes included in the list of maintenance requirements with the indexed aircraft records entries.

FIG. 1G is a diagram of the records management platform determining compliance of the aircraft with respective maintenance task requirements, and providing the user with a compliance report for the aircraft.

FIG. 2 is a diagram of an example process for using machine learning to train a data model to make predictions relating to aircraft maintenance and/or recordkeeping.

FIGS. 3A-3D are diagrams of an example process for using the trained data model to generate a compliance report includes predictions and recommendations relating to aircraft maintenance and/or recordkeeping.

FIG. 4 is a diagram of an example environment in which systems and/or methods described herein may be implemented.

FIG. 5 is a diagram of example components of one or more devices of FIG. 4.

FIGS. 6A-6E are diagrams of an example process for performing aircraft records management services in accordance with the principles of the present disclosure.

FIG. 7A-7C diagrams of another example process for performing aircraft records management services in accordance with the principles of the present disclosure.

FIG. 8 is a diagram of another example process for performing aircraft records management services in accordance with the principles of the present disclosure.

FIG. 9 is a diagram of another example process for performing aircraft records management services in accordance with the principles of the present disclosure.

FIG. 10A is a diagram of an example user interface of a library view of an aircraft records management application.

FIG. 10B is a diagram of an example user interface of the library view that includes a timeline of events for items selected from a virtual shelf.

FIG. 10C is a diagram of an example user interface of the library view that includes a detailed view of one or more maintenance requirements for an aircraft.

### DETAILED DESCRIPTION

The following detailed description of example embodiments refers to the accompanying drawings. The same reference numbers in different drawings may identify the same or similar elements.

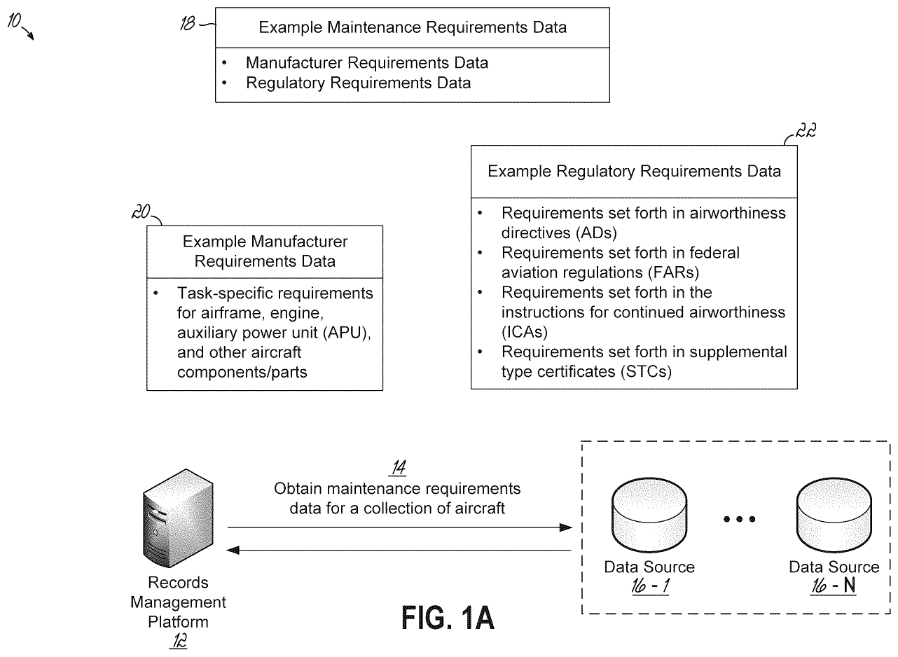

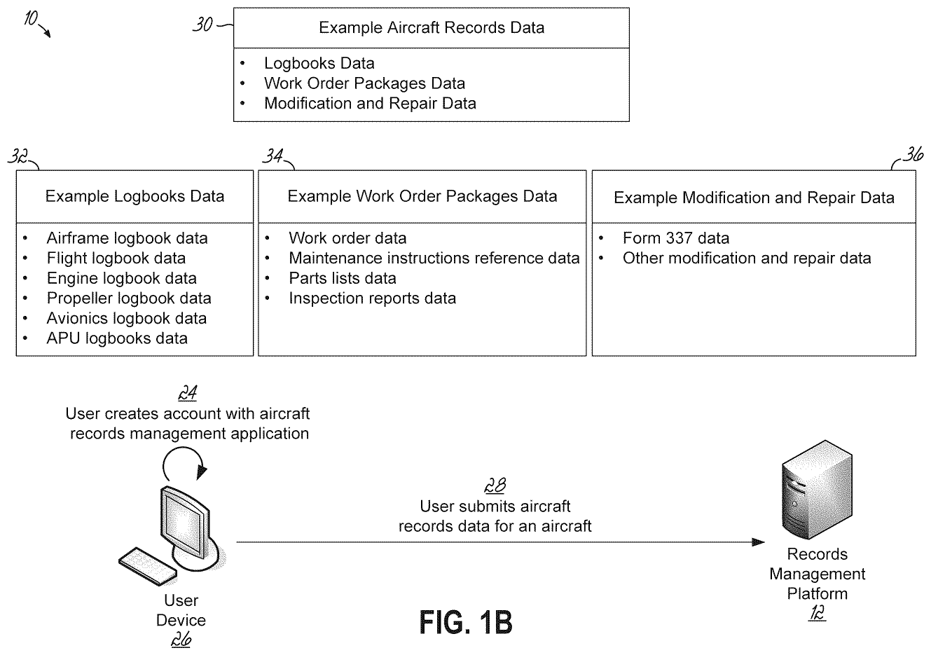

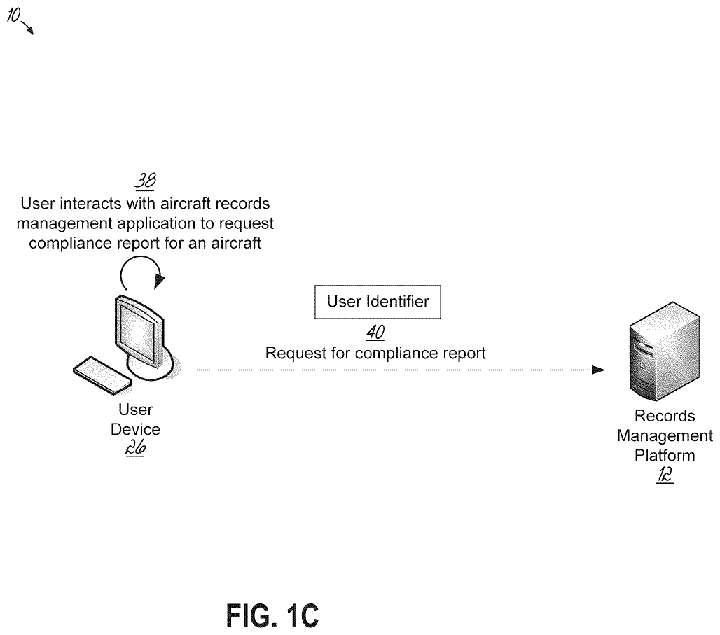

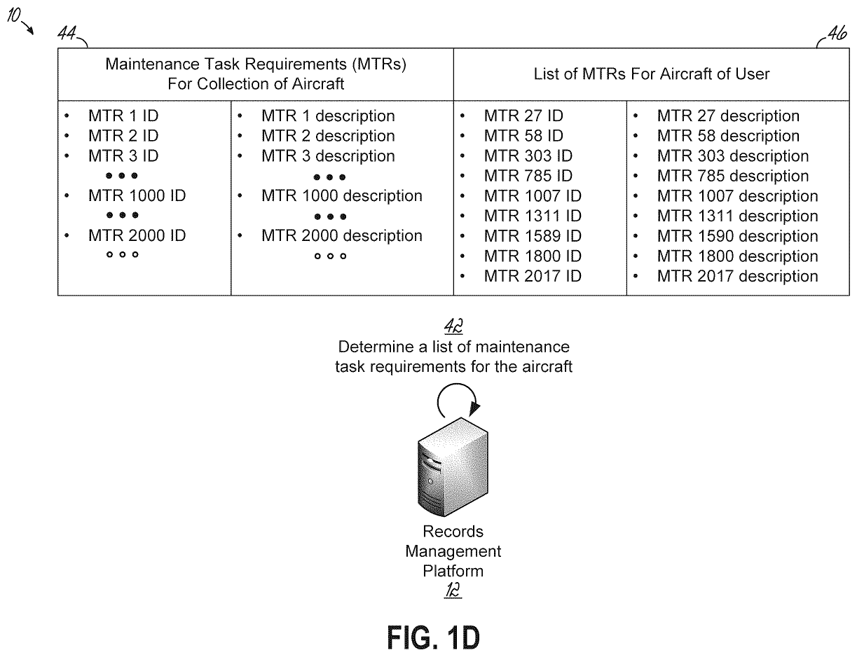

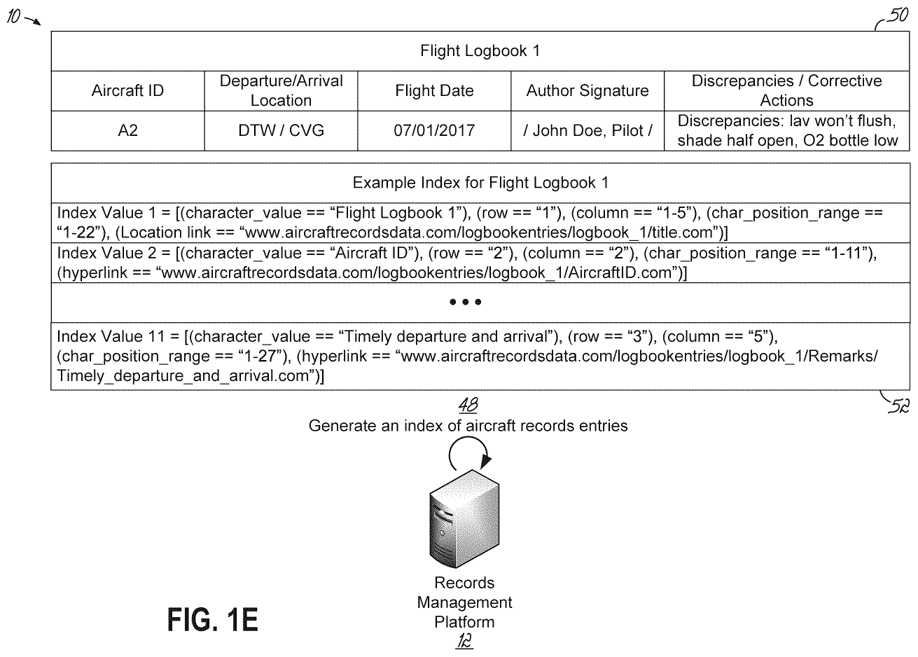

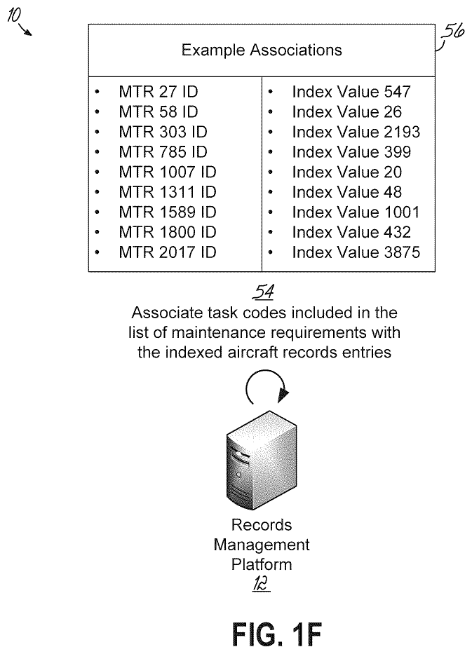

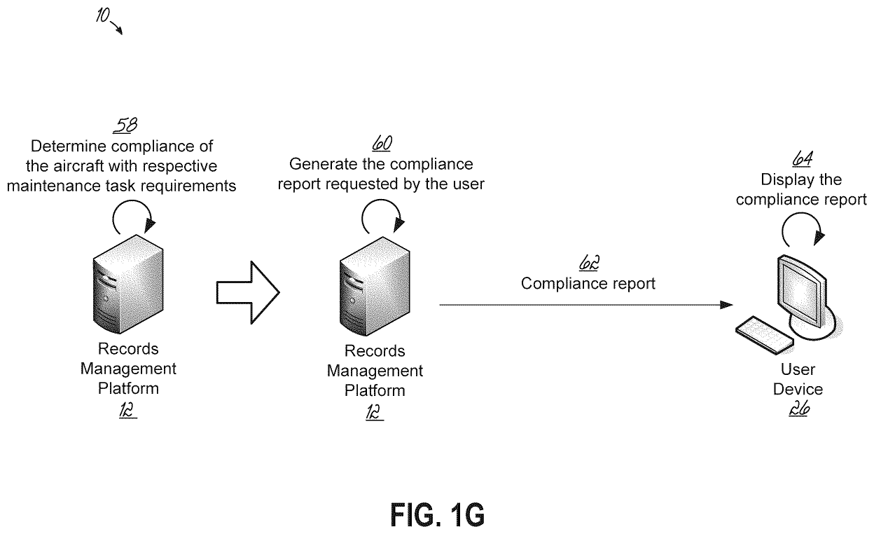

FIGS. 1A-1G are diagrams of an example method 10 for using a records management platform 12 to manage aircraft records and compliance with aircraft maintenance requirements. For example, the records management platform 12 may support an aircraft records management application that is accessible to a group of registered users. The records management platform 12 may store, or have access to, maintenance requirements data for a collection of aircraft, as well as aircraft records data for aircraft owned and/or operated by the registered users. As will be shown herein, a user may log into the records management application, and may request that the records management platform 12 generate a compliance report to assist in managing compliance with maintenance requirements. The user may then use the compliance report to determine compliance of the user's aircraft with the maintenance requirements. Additionally, the user may use the compliance report to perform one or more actions needed comply with, or to remain in compliance with, the maintenance requirements.

As used herein, the term “maintenance,” or other similarly used terminology, includes any act of maintenance, repair, inspection, overhaul, modification, and/or related type of event or activity. For example, a maintenance task may refer to an inspection of a component of an aircraft, an act of repairing, overhauling, modifying, and/or replacing a component of an aircraft, and/or any other action associated with completing requirements of a maintenance task.

As shown in FIG. 1A by reference number 14, the records management platform 12 may obtain, from a group of data sources (shown as data source 16-1 through data source 16-N), maintenance requirements data for a collection of aircraft. The maintenance requirements data may specify requirements for managing, maintaining, and/or operating different types of aircraft.

The maintenance requirements data may be obtained over a network (e.g., the Internet, etc.) via a communication interface, such as an application programming interface (API) or a similar type of interface. The group of data sources may, for example, include webpages that publish one or more of the different types of maintenance requirements data that are described herein.

In some embodiments, the records management platform 12 may obtain the maintenance requirements data using one or more web crawling techniques. Additionally, or alternatively, the records management platform 12 may obtain the maintenance requirements data using one or more other techniques known in the art.

As shown by reference number 18, the maintenance requirements data may include manufacturer requirements data, regulatory requirements data, and/or the like. Each of these example types of maintenance requirements data is described below. In practice, other types of maintenance requirements data may be obtained.

The manufacturer requirements data may be part of a maintenance requirements document provided by an equipment manufacturer, such as an original equipment manufacturer (OEM). The manufacturer requirements data may include data identifying task-specific maintenance requirements for components of an aircraft, such as task-specific maintenance requirements for an airframe, an engine, an auxiliary power unit (APU), a propeller, a rotor, a piece of landing gear, a cockpit voice recorder, an underwater locator beacon, a battery, and/or the like. Additionally, or alternatively, the manufacturer requirements data may include data identifying task-specific maintenance requirements for parts of an aircraft. That is to say, a component may consist of one or more parts, and certain maintenance requirements may apply to one or more of the parts of a given component.

The manufacturer requirements data for each maintenance task that is performed on a component and/or part of an aircraft may include data in one or more of the following fields: a task code field, a source document name field, a revision number field, an air transport association (ATA) chapter (CH) field, an interval field, an inspection group field, a position field, a component number field, a part number field, an aircraft serial number range field, a dependencies field, and/or the like. Additionally, or alternatively, the manufacturer requirements data may include data in fields such as a previous compliance field, a change details field, a service bulletin relations field, a pre/post modification field, an equipment configuration field, and/or the like.

The task code value is a unique identifier identifying a given maintenance task. The source document name value identifies the source providing the data. The revision number value identifies the version of the maintenance requirement, as certain maintenance requirements change over time. The ATA CH value identifies a chapter in a maintenance requirements document in which the given maintenance task is described. That is to say, multiple maintenance requirements may be grouped into the same chapter, if for example these maintenance requirements share certain characteristics or properties.

The inspection group value identifies a group of inspections to be performed at the same time or as part of the same inspection group. Inspection groups may be designated using an alpha, numerical, or alpha-numerical identifier. Example inspection groups may include an A-check inspection group, a B-check inspection group, a 2C inspection group, 1,000-hour inspection group, 1,000 landings inspection group, and/or the like. The position value identifies the position of the component or part within the aircraft. For example, a position value may identify that a component or part is located at an inboard, outboard, forward, or aft portion of the aircraft.

The component number value is a unique identifier of a given component. The part number value is a unique identifier of a given part. The serial number range value identifies a range of serial numbers to which a given maintenance task applies. The dependencies value identifies conditions that make a given maintenance task applicable or not applicable based on whether the dependency is present. For example, the part number value may be listed as a dependency value, indicating that the given maintenance task only applies to parts with part numbers listed as a dependency value. Additionally, or alternatively, the dependency value may include a country of operations value, a pre-or post-modification value, an aircraft serial number, an age of an aircraft, aircraft component, or aircraft part, and/or the like.

As shown by reference number 22, the regulatory requirements data may include data identifying regulatory requirements of one or more nations. In the example shown, regulatory requirements data is provided for the United States, which includes requirements set forth by airworthiness directives (ADs), requirements set forth in the Federal Aviation Regulations (FARs), requirements set forth in instructions for continued air worthiness (ICAs), requirements set forth in one or more supplemental type certificates (STCs), and requirement set forth in one or more advisory circulars (ACs). In practice, the regulatory requirements data may include data from one or more other regulatory sources of the United States, and/or data from one or more other regulatory sources of other nations.

An AD is issued by the Federal Aviation Administration (FAA) to notify an aircraft owner of potentially unsafe conditions identified in certain aircraft components/parts. The AD specifies the unsafe condition or defect, as well as the action that must be taken to address the unsafe condition or defect. The regulatory requirements data for each AD may include data in fields such as an AD number field, an AD revision number field, an AD subject/title field, an effective issue date field, an applicability field, an AD paragraph field, condition data identifying an unsafe condition or defect, action data identifying one or more actions to be taken to address the unsafe condition or defect, and/or the like.

To provide a specific example, an AD number field may include a value representing a unique identifier of a given AD. The revision number field may include a value identifying the version or revision number of the AD. The subject/title field may include a value identifying a broad subject or title of the AD. For example, an AD relating to an electrical power issue may include a subject/title field value of “electrical power”. The effective issue date field may include a value identifying a date at which enforcement of the AD begins. The applicability field may include a value identifying a make and/or model of an aircraft to which the AD applies.

Additionally, or alternatively, the applicability field may include a value identifying a serial number range of aircraft to which the AD applies. The AD paragraph field may include a value identifying a paragraph number, a portion of a paragraph, etc.

Regulatory requirements data for FARs includes data identifying aircraft weight requirements, flight data recorder (FDR) requirements, fire safety requirements (e.g., involving the use and positioning of a fire extinguisher, egress aisle widths, exit door banding, life vest and life raft capacity, etc.), health safety requirements (e.g., involving the use and positioning of first aid kits, etc.), transponder maintenance requirements, emergency locator transmitter requirements, height monitoring requirements involving a reduced vertical separation minimum (RSVM), and/or the like. This data may include one or more fields described above and/or one or more additional fields specific to a given FAR.

Some regulatory requirements address modifications or alterations to the aircraft, such as data identifying requirements set forth in instructions for continued airworthiness (ICAs), data identifying requirements set forth in one or more supplemental type certificates (STCs), and/or the like. ICAs are instructions provided by an aircraft manufacturer to ensure that aircraft components/parts meet certain airworthiness requirements throughout the operational life of the aircraft. In some cases, ICAs are provided in the form of a maintenance manual that details how to perform maintenance tasks, repairs, modifications, and/or the like. ICAs are often tailored to the specific make, model, and/or serial number of the aircraft. ICAs may also include information relating to the design, construction, and operation of an aircraft and the aircraft's components/parts. Failure to comply with an ICA may lead to penalties or loss of license or certificate.

The modification and repair requirements data for an ICA may include data in an ICA document number field, an ICA document title field, an ICA task code field, a task description field, a task interval field, and/or the like.

STCs are a certification issued by the FAA that allows an aircraft owner/operator to modify an existing aircraft component beyond its original design or manufacturing specification. Obtaining an STC requires detailed engineering and testing of any modifications and the certification represents that the modification is approved with the FAA. The modification and repair requirements data for an STC may include data in an applicability field, an STC number field, an STC title field, an STC holder field, and/or the like.

In some embodiments, the records management platform 12 may store the maintenance requirements data. For example, the records management platform 12 may store the maintenance requirements data using one or more data structures. The one or more data structures may associate identification for respective aircraft with sets of maintenance task requirements for the respective aircraft in the group.

Over time, new versions of certain maintenance requirements may be released. Additionally, or alternatively, new maintenance requirements may be released. For this reason, the records management platform 12 may periodically obtain new maintenance requirements data, such that the maintenance requirements data stored reflects current maintenance requirements.

In some embodiments, the records management platform 12 may standardize the maintenance requirements data. For example, the records management platform 12 may standardize the maintenance requirements data into a uniform file type and/or format.

In some embodiments, the records management platform 12 may obtain maintenance tracking report data for the aircraft from one or more third party data sources. The maintenance tracking report data may further document the maintenance history of the aircraft. The maintenance tracking report data may provide a detailed history of the maintenance activities performed on the aircraft, including inspections, repairs, and/or modifications.

In some embodiments, the records management platform 12 may reconcile the maintenance requirements data and the tracking report data. For example, the records management platform 12 may compare the maintenance tracking report data with the maintenance requirements data and may place compared values into three groups: a group where values in the maintenance tracking report data match values in the maintenance requirements data, a group where a value is present in the maintenance tracking report data but not in the maintenance requirements data, and a group where a value is present in the maintenance requirements data but not in the maintenance tracking report data. In this case, the records management platform 12 may use one or more of the identified differences to update the maintenance requirements data. In some embodiments, the identified differences may be included in a summary report provided to a user of the aircraft records management application.

In this way, similar maintenance requirements data may be obtained from multiple data sources, and the records management platform 12 may reconcile this data so as to create a single, accurate, uniform repository of maintenance records data.

As shown in FIG. 1B, and by reference number 24, a user may interact with a user device 26 to create an account with the aircraft records management application. For example, the user may create an account that includes a username and password. As shown by reference number 28, the user device 26 may provide aircraft records data for an aircraft to the records management platform 12. For example, the user may interact with a user interface of the aircraft records management application to submit aircraft records data for an aircraft, which may cause the aircraft records data to be provided to the records management platform 12. The user may be the owner of the aircraft or an employee of an approved representative (e.g., a mechanic, a broker, a management company, etc.).

The aircraft records data is used to maintain aircraft records and to track and/or satisfy one or more of the aircraft maintenance requirements. The aircraft records data may be provided over a network via an API or a similar type of communication interface known in the art.

As shown by reference number 30, the aircraft records data may include logbooks data, work order packages data, modification and repairs data, and/or the like. It is to be understood that these are provided by way of example, and that in practice, other types of aircraft records data may be received and used for providing the one or more aircraft records management services.

A logbook is a recordkeeping document that tracks maintenance throughout the operational life of an aircraft. A logbook provides a history of an aircraft's maintenance activities. The logbook data provides an electronic record of the logbook entries created when maintenance was performed on the aircraft. As shown by reference number 32, the logbooks data may include airframe logbook data, flight logbook data, engine logbook data, propeller logbook data, APU logbook data, and/or the like.

The airframe logbook data identifies maintenance performed on structural components of an aircraft including the fuselage, wings, landing gear, and more. The flight logbook data identifies a duration of each flight, a date, a departure airport, a destination airport, and/or the like. In some embodiments, the flight logbook data may also include maintenance records data. The engine logbook data identifies maintenance performed on the engines of the aircraft. The propeller logbook data identifies maintenance performed propellers of the aircraft. The APU logbook data identifies maintenance and operational history of the APU of the aircraft.

Logbook data may include data in fields such a date field, a field indicating a type of maintenance performed, a field indicating an individual or entity who performed the maintenance, a parts field indicating a part in which the maintenance was performed on, a next inspection date field indicating a date at which the next inspection needs to occur before (e.g., to maintain compliance with airworthiness regulations), and/or the like.

In some embodiments, logbooks may be recorded in physical form. In this case, each respective physical copy of a logbook may be scanned such that an electronic copy of the logbooks is created. The electronic copy of the logbook may be provided to the records management platform 12.

A work order package is a comprehensive set of documents that detail one or more maintenance tasks performed on an aircraft. As shown by reference number 34, work order package data may include data identifying a work order, maintenance instructions reference data, parts lists data, inspection reports data, and data included in other related documents. As would be understood by one skilled in the art, instructions can only be sourced for purposes of maintenance compliance. That is to say, maintenance instructions references can be accessed, but not the maintenance instructions themselves. The maintenance instructions themselves may, for example, be provided in a maintenance manual of a manufacturer.

Work order packages data may include data in a date field, a parts description field, a part number field, a serial number field, a status field, component data fields, and/or the like. The date field specifies a date when a form is used for a component being worked on. The parts description field describes a part that is subject to the maintenance activity. The part number field is a unique identifier assigned to a specific component or part by the manufacturer. The serial number field is a unique identifier assigned to a specific component or part by the manufacturer. The status field indicates a status of the component or part, such as whether the component or part is being repaired, overhauled, or modified. The status field can also provide information on inspections or tests performed on the part, as well as the result of those inspections/tests. The component data fields may indicate, for a particular component, a part number, serial number, manufacturer identifier, date during which the last test was performed on the component, and/or the like.

In some embodiments, the work order packages data may include forms from multiple different sources. For example, the work order packages data may include data found in an 8130 form, a continuous airworthiness maintenance program (CAMP) form, a certificate of conformance form, a burn certificate form, and/or the like. As would be understood by one skilled in the art, there may be thousands of different types of work order form with varied formats.

As shown by reference number 36, the modification and repair data may include form 337 data and other modification and repair data. A form 337 is a form used to record repairs and/or alterations made to the aircraft. Other modification and repair data may include data in work order forms, logbook entries, parts lists, and/or the like. To provide specific examples, the modification and repair data may include data in fields such as a date field (e.g., a 337 date), a summary description field, an instructions for continued airworthiness (ICA) document number field, a maintenance data collection (MDC) number field, an individual modification accomplished field, a supplemental type certificate (STC) number or 8110-3 date field, an aircraft flight manual supplement (AFMS) number field, and/or the like.

In some embodiments, the aircraft records data may further include aircraft identification information for the aircraft. The aircraft identification information may identify a serial number of the aircraft, a make of the aircraft, a model of the aircraft, a year in which the aircraft was made, and/or the like.

In some embodiments, the records management platform 12 may store the received data. For example, the records management platform 12 may store the aircraft records data using one or more data structures.

As shown in FIG. 1C, and by reference number 38, the user may interact with the aircraft records management application to request a compliance report for an aircraft. As shown by reference number 40, the request is transmitted to the records management platform 12. The request may include an identifier that identifies the account of the user and/or the aircraft of the user. The compliance report may include one or more summary reports and/or one or more detailed reports that describe the compliance of the aircraft with aircraft maintenance requirements and/or that describe maintenance tasks to be completed to maintain compliance.

As shown in FIG. 1D, and by reference number 42, the records management platform 12 may determine a list of maintenance task requirements for the aircraft. For example, the maintenance requirements data may identify maintenance task requirements for various types of aircraft. However, some of these maintenance task requirements may not be applicable to the user's aircraft. Consequently, the records management platform 12 may filter through the maintenance requirements data to determine a list of maintenance task requirements that are applicable to the aircraft of the user.

In some embodiments, the records management platform 12 may use the make, model, and year of the aircraft to search the maintenance requirements data to identify one or more maintenance task requirements that are applicable to the aircraft. For example, the maintenance requirements data may include task code fields for certain tasks, where the task code fields are stored in association with an “applicability” field that identifies the make or model of the user's aircraft. In this case, the records management platform 12 may add the task code to the list of maintenance task requirements, and may store the maintenance task requirements as maintenance task requirements data.

Additionally, or alternatively, the records management platform 12 may process the aircraft records data to locate component identifiers for a group of components that are part of the aircraft. In this case, the aircraft records management platform 12 may use the component identifiers to search the maintenance requirements data for one or more matching or corresponding component identifiers that are stored in association with maintenance task codes for applicable maintenance task requirements.

As can be appreciated by one skilled in the art, other keywords may be used to determine the list of maintenance task requirements. For example, the aircraft records data of the aircraft may include data identifying a make or model of the propeller, which may be used to determine one or more maintenance task requirements that are specific to a propeller with the specified make or model.

A simplified depiction of this process is shown by reference numbers 44 and 46. In this depiction, the records management platform 12 searches through more than 2,000 maintenance task requirements for the collection of aircraft to determine that the following maintenance task requirements are applicable to the aircraft of the user: MTR 27, MTR 58, MTR 303, MTR 785, MTR 1007, MTR 1311, MTR 1590, MTR 1800, and MTR 2017. It is to be understood that this is provided by way of example, and that in practice, an even greater great number of maintenance task requirements may be included in the maintenance requirements data and/or applicable to the aircraft of the user.

The list of maintenance task requirements may be stored as maintenance task requirements data. The maintenance task requirements data may be a subset of the maintenance requirements data, and may include task code data identifying a task code for a given maintenance task, description data that describes a task, inspection type data indicating a type of inspection performed, time data indicating a date on which an inspection was performed, and/or the like. To provide a specific example, the maintenance task requirements data for a required inspection of an aircraft engine may include task code data (e.g., an identifier unique to the type of inspection), description data describing the inspection, inspection type data indicating the type of inspection that has to be performed on the engine, and interval data indicating a frequency at which the inspection has to be performed. In some embodiments, the records management platform 12 may store the maintenance task requirements data in association with an account identifier for the user's account and/or with one or more aircraft identifiers for the aircraft of the user.

In this way, the records management platform 12 determines the list of maintenance task requirements for the aircraft. Furthermore, the records management platform 12 determines an accurate, up to date list of maintenance task requirements, despite that the requirements are provided across multiple data sources, in different file types/formats, and/or with duplicative types of data across the data sources.

As shown in FIG. 1E, and by reference number 48, the records management platform 12 may generate an index of aircraft records entries. The records management platform 12 may have access to one or more databases (e.g., text databases, images databases, etc.) that provide the records management platform 12 with a labeled schema that can be used to create the index of aircraft records entries. For example, to generate an index for logbook entries, the platform 12 may have access to an images database that provides facility logbook entry formats and/or FAA form formats. Similar databases may be accessed for the work order packages data and/or the modification and repair data.

To generate the index, the records management platform 12 may establish associations between the aircraft records entries and their spatial positioning within a record. For example, the records management platform 12 may establish associations between aircraft records entries and spatial positioning values that identify the spatial positioning of aircraft records entries within a given record. The spatial positioning values may refer to a page number on which an entry occurs, a paragraph number, a line number, a position within a line in which the first character and/or last character of an occurs, and/or the like.

To provide an example, the records management platform 12 may generate an index of logbook entries. For example, the records management platform 12 may establish associations between logbook entries and spatial positioning values that correspond to the position of each respective logbook entry within a logbook.

In the example shown by reference number 50, the logbook may be a flight logbook. The flight logbook typically includes a title, a list of content to be recorded, and a series of blank lines that can be filled in by a user for each entry. The flight logbook shown in FIG. 1E has one entry, which includes an aircraft identifier “A2”, a departure location of “DTW”, an arrival location of “CVG”, a flight date of Jul. 1, 2017, a pilot signature of “/John Doe, Pilot/”, and a discrepancy or corrective actions section indicating a “Opened work order A0G-E2273 for discrepancies such as: lav won't flush, shade half open, and O2 bottle low.”

As shown by reference number 52, the records management platform 12 may generate an index of the flight logbook entries. For example, the records management platform 54 may generate an index with eleven index values. The first, second, and eleventh index values are shown. For example, the first index value associates the value for the logbook entry title (e.g., character_value==Flight Logbook 1) with the relative positioning of the entry within the flight logbook (e.g., “Row==“1”, column==1, char_position_range==1). The records management platform 54 may further associate this data with a link to the specific location within the flight logbook (e.g., hyperlink==“www.aircraftrecordsdata.com/logbookentries/logbook_1/title.com”). This allows the platform 54 to provide a link to the specific location of the content being cited, as will be described further herein. The index shown is intended solely to illustrate the relationship between different types of data values. In practice, the index may utilize any organization structure known in the art.

Additionally, or alternatively, the records management platform 12 may generate an index that includes work order entries and/or modification and repair entries. The records management platform 12 may generate the index for the work order entries and/or the modification and repair entries in the same or similar manner to that described in connection with the logbook entries. Furthermore, the logbook entries, work order entries, and modification and repair entries may be represented in the same index or in separate indices.

In some embodiments, the records management platform 12 may only index relevant keywords included in the aircraft records entries. For example, the records management platform 12 may process the aircraft records data to identify keywords that are relevant for compliance with maintenance requirements. The keywords may be words or phrases that are relevant to compliance with maintenance task requirements, such as a document title, a maintenance task code if provided, a component or part on which maintenance was performed, a date, a location or facility, and/or any other keyword relevant to compliance with a maintenance task. The date field may identify a date on which a logbook entry was made, a date on which a work order was made, a date on which maintenance was performed on the aircraft, etc. The location or facility may identify a location or facility in which maintenance was performed, or in the case of a logbook entry, may identify a departure location or arrival location. To provide a few other examples, the keywords may include words or phrases used in a description field that describes the task that was performed, such as repair, technical variance, burn, flammability, and/or the like.

To identify the keywords, the records management platform 12 may process the aircraft records data using one or more natural language processing techniques and/or one or more relevancy techniques. For example, the aircraft records data may be processed using a tokenization technique, a parts of speech (POS) tagging technique, a named entity recognition (NER) technique, a term frequency-inverse document frequency (TF-IDF) technique, a keyword extraction technique, a topic modeling technique, a word embeddings technique, a keyword filtering technique, and/or any other technique known in the art. These techniques provide the records management platform 12 with a mechanism for identifying keywords which are then indexed in the same or similar manner as that described above. By generating an index using keywords, the records management platform 12 optimizes a utilization of processing resources and/or storage resources relative to generating an index without the use of keywords.

In some embodiments, the records management platform 12 may update one or more of the aircraft records entries. For example, the records management platform 12 may use one of the natural language processing techniques described above to determine that a data entry includes a typographical error or a short-hand notation of a value. In this case, the records management platform 12 may update the value, or prompt the user to update the value, to reflect the value intended by the individual who input the data. As a specific example, a flight logbook for the aircraft might list “A2” as an aircraft identifier for the first five entries, but may list “Q2” as the aircraft identifier for the sixth entry. In this case, the records management platform 12 may flag the entry and may prompt the user with a notice requesting that the user clarify whether this entry was proper. The prompt may be displayed on a user interface of the user device 26, and the user may select whether or not to have this entry corrected.

In some embodiments, such as when the logbooks data is missing relevant information, the records management platform 12 may provide a request to a user device (e.g., a device of the aircraft owner or management company) to request the relevant missing information.

As shown in FIG. 1F, and by reference number 54, the records management platform 12 may associate task codes included in the list of maintenance requirements with indexed aircraft records entries. For example, the records management platform 12 may use a data structure to associate task codes included in the list of maintenance requirements with corresponding indexed aircraft records entries. This allows the records management platform 12 to associate each task code for a maintenance task requirement with aircraft records entries for a given aircraft record. In this way, aircraft records entries may be stored in association with the task code for the maintenance task requirement.

Reference number 56 provides example associations between maintenance task codes and indexed values of aircraft records entries. This is provided by way of example. In practice, multiple maintenance task codes may be associated with the same aircraft record entry. Similarly, multiple aircraft record entries may be associated with the same maintenance task code.

In some embodiments, the records management platform 12 may generate one or more pointers for the aircraft records entries. For example, the records management platform 12 may generate a pointer (e.g., a hyperlink, etc.) to a location in the original electronic aircraft record in which the entry is found. By generating pointers, the records management platform 12 allows the user to verify compliance with a maintenance requirement by viewing the aircraft records entries corresponding to that maintenance requirement as they are shown in the original electronic document.

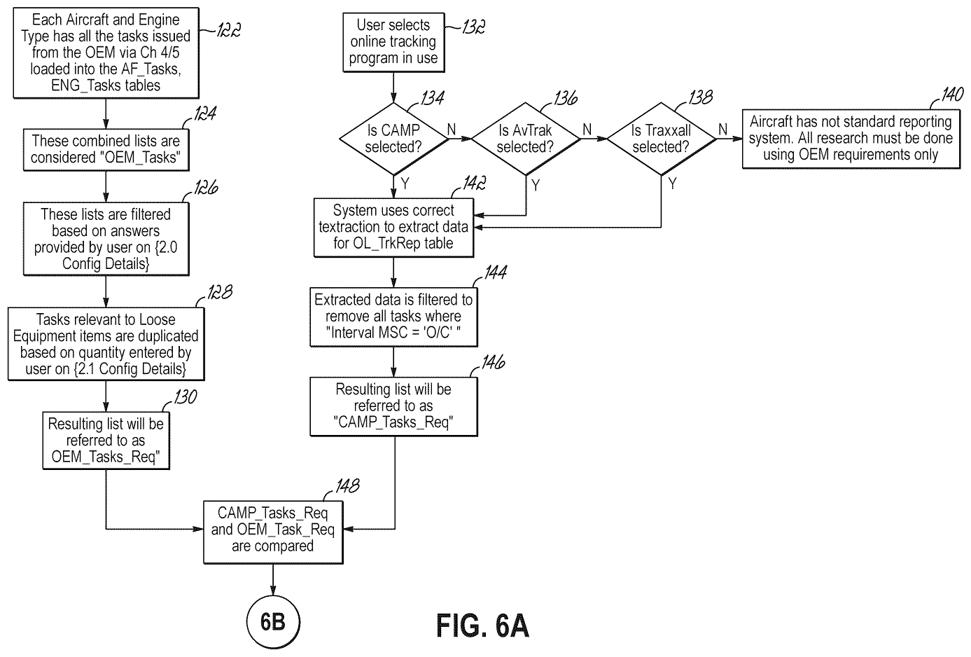

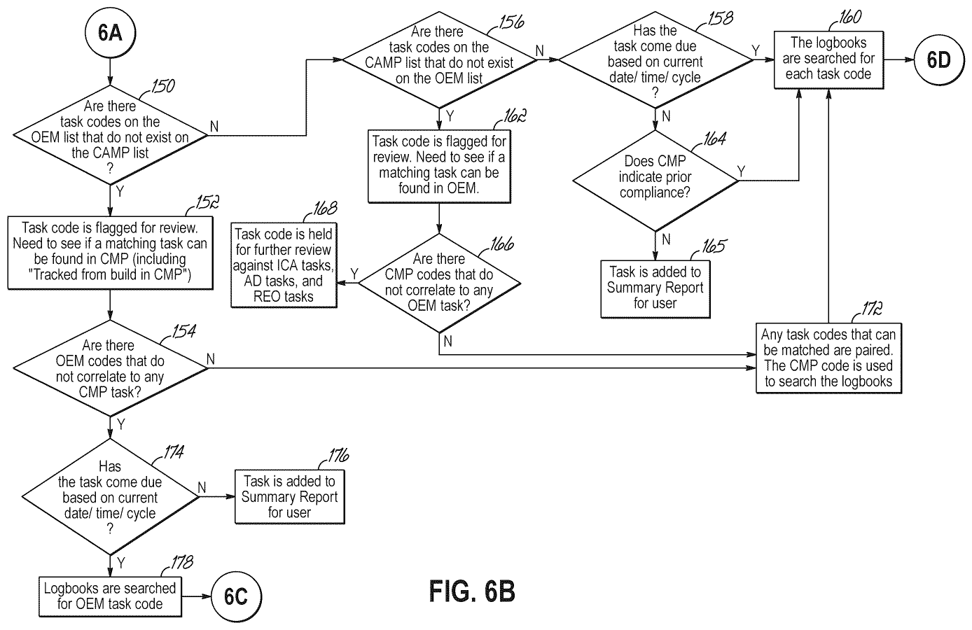

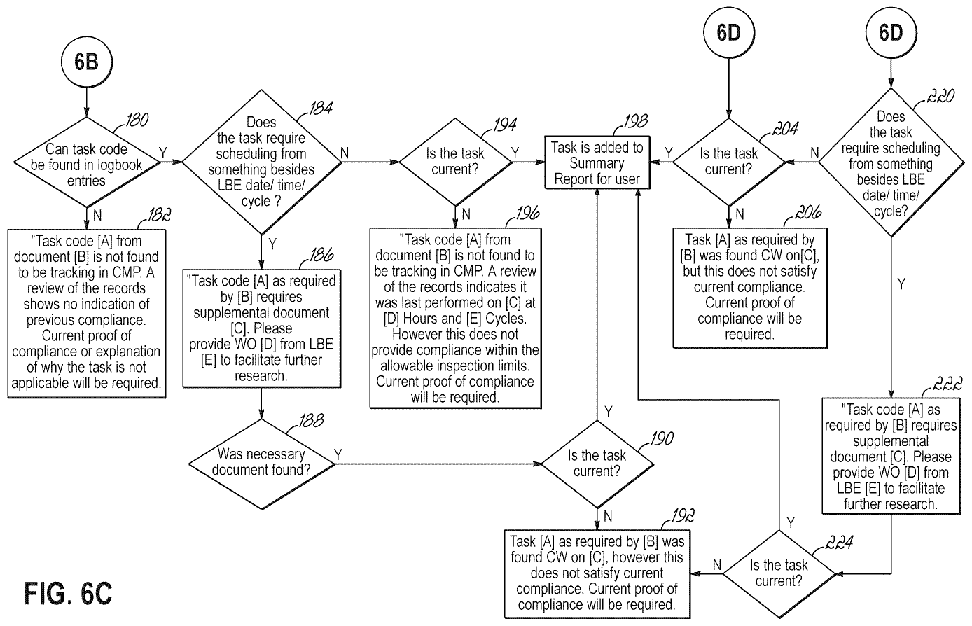

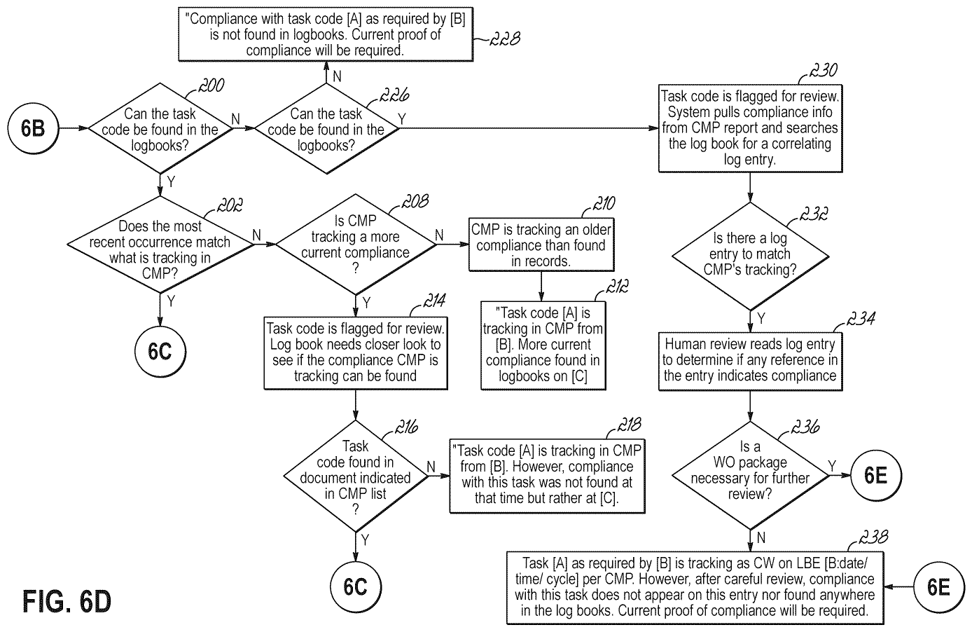

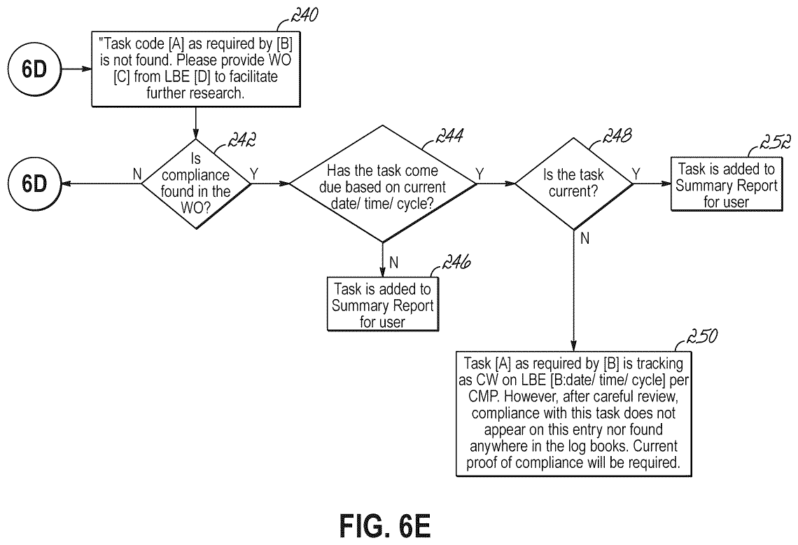

As described above, the records management platform 12 may have reconciled the maintenance requirements data with maintenance tracking report data from third party sources. Similarly, in some embodiments, the records management platform 12 may reconcile the aircrafts records entries with the maintenance tracking report data. An additional description on the reconciliation of maintenance tracking report data with the maintenance requirements data and/or the aircraft records data is provided in connection with FIG. 6A.

In some embodiments, the records management platform 12 may use the reconciled data to determine aircraft records entries for certain maintenance tasks. For example, the records management platform 12 may use the reconciled data to determine work order numbers corresponding to one or more maintenance tasks. In this case, the records management platform 12 may process the maintenance tracking report data to identify relevant values included in the maintenance tracking report data. Relevant values included in the maintenance tracking report data may, for example, include task values for tasks that include an interval value, which can be sorted to identify unique occurrences of dates, times, cycle counts, etc. Next, the records management platform 12 may cross-reference the logbook entries against the values included in the maintenance tracking report data values to determine the work order for each maintenance task.

As shown in FIG. 1G, and by reference number 58, the records management platform 12 may determine the compliance of the aircraft with respective maintenance task requirements. First, the records management platform 12 may identify aircraft records entries to be used as compliance values for respective maintenance task requirements. To do this, the records management platform 12 may use search keys to search the indexed aircraft records entries to identify aircraft records entries that are relevant to compliance with one or more maintenance task requirements. In some embodiments, the search keys may include a set of maintenance task identifiers, such as an airworthiness directive (AD) number, a service bulletin (SB) number, a customer bulletin (CB) number, an aircraft customer bulletin (ACB) number, a FARs identifier, an ICA identifier, an STC identifier, a manufacturer identifier, and/or the like. Additionally, or alternatively, the search keys may include a set of maintenance task description values, such as a date, a time, a cycle count and/or cycle interval, a facility number, a maintenance task description, and/or any other keyword relevant to determining compliance with a maintenance task requirement.

In some embodiments, the records management platform 12 may determine compliance with the respective maintenance task requirements. For example, the records management platform 12 may process the identified aircraft records entries using one or more compliance rules to determine whether the aircraft complies with a given maintenance task requirement.

The one or more compliance rules may be specific to a given compliance requirement. That is to say, each respective maintenance task requirement may require the performance of different tasks, and the records management platform 12 may utilize one or more compliance rules specific to each task. For example, smoking on an aircraft is prohibited.

However, waste containers (e.g., ash trays, etc.) must be provided on aircraft as a preventative measure. AD #74809 requires that for every 1,000 flight hours, the aircraft be inspected to verify whether these waste containers are present. The compliance rule may be used to check whether this inspection has been performed within the required time window. For example, the compliance rule may be that a date during which the waste containers were most recently inspected must be within the past 1,000 flight hours. As can be understood by one skilled in the art, other compliance rules may be implemented so as to verify compliance with respective maintenance task requirements. Additional compliance rules are described in connection with FIGS. 6-9.

In some embodiments, the records management platform 12 may determine a degree to which a compliance rule has been satisfied. For example, in some situations, a mandatory inspection may have been performed, but recordkeeping for the inspection may be insufficient to satisfy an additional requirement that certain documentation of the inspection be provided. In this situation, the records management platform 12 may determine which aspects of compliance have been satisfied, and which aspects of compliance have yet to be satisfied.

To provide an example of determining compliance, assume the records management platform 12 is to verify compliance with AD #74809. In this example, the records management platform 12 may use an AD number as a search key to identify an aircraft record that includes the AD number. Next, the records management platform 12 may identify, within the aircraft records, a location of an aircraft records entry that includes compliance values relevant to AD #74809. For example, a logbook entry may have a field with AD #74809 and a neighboring field that describes that the most recent inspection was performed on Jan. 18, 2024. Next, the records management platform 12 may further process aircraft records to identify a total number of flight hours between Jan. 18, 2024, and a current date. The records management platform 12 may then determine compliance based on whether the total number of flight hours is less than 1,000 hours.

As shown by reference number 60, the records management platform 12 may generate the compliance report requested by the user. The compliance report may describe the maintenance requirements applicable to the aircraft, current compliance with those maintenance requirements, and/or upcoming dates in which maintenance tasks need to be performed in order to remain in compliance.

The compliance report may be a research report, a summary report, a work scope report, and/or the like. The research report may provide a detailed explanation as to compliance with the maintenance requirements. The summary report may summarize compliance with the maintenance task requirements. For example, the summary report may identify one or more compliance issues found with the aircraft and/or may describe one or more proposed solutions to correct the compliance issues. The work scope report may describe actions needed to bring the aircraft into compliance with the maintenance requirements.

In some embodiments, the records management platform 12 may generate multiple reports. In some embodiments, the report may be tailored to provide information specified by the user. For example, if the user wants a compliance report for a certain component or part of the aircraft, the records management platform 12 may generate a report providing only the compliance information for the requested component or part. To provide another example, if the user wants a compliance report for a certain date range, the records management platform 12 may generate a report providing compliance information only for the requested date range.

In some embodiments, the records management platform 12 may generate a report that includes links to the relevant aircraft records entries. For example, assume the records management platform 12 generates a report indicating that the user successfully complied with the requirements to perform on-time maintenance for all required ADs. In this case, the records management platform 12 may provide links to one or more logbook entries to verify compliance. In this way, the records management platform 12 provides the user with proof of compliance.

As shown by reference number 62, the records management platform 12 may provide the compliance report to the user device 26. As shown by reference number 64, the user device 26 may provide the compliance report for display on a user interface. This allows the user to view the compliance report, quickly ascertain whether the aircraft is compliant with maintenance requirements, and to identify upcoming dates in which maintenance tasks need to be performed in order to remain in compliance.

In this way, the records management platform 12 provides a more efficient, streamlined process, thereby improving the speed needed to comply with aircraft maintenance regulations while improving on the accuracy of the aircrafts records themselves. Furthermore, the records management platform 12 reduces a likelihood of a safety-related incident occurring by ensuring that the aircraft is under compliance and that compliance is achieved in a timely and organized manner.

As indicated above, FIGS. 1A-1G are provided merely as an example. Other examples may differ from what is described with regard to FIGS. 1A-1G. For example, there may be additional devices and/or networks, fewer devices and/or networks, different devices and/or networks, or differently arranged devices and/or networks than those shown in FIGS. 1A-1G. Furthermore, two or more devices shown in FIGS. 1A-1G may be implemented within a single device, or a single device shown in FIGS. 1A-1G may be implemented as multiple and/or distributed devices.

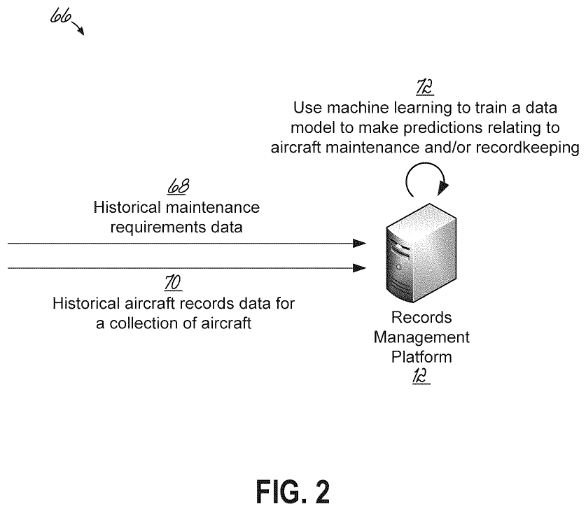

FIG. 2 is a diagram of an example process 66 for using machine learning to train a data model to make predictions relating to aircraft maintenance and/or recordkeeping. For example, the records management platform 12 may receive historical data and may train a data model to analyze the historical data in order to make predictions relating to aircraft maintenance and/or recordkeeping.

As shown by reference number numbers 68, the records management platform 12 may receive historical maintenance requirements data. The historical maintenance requirements data may correspond to the maintenance requirements data described in connection with FIG. 1A.

As shown by reference number 70 the records management platform 12 may receive historical aircraft records data for a collection of aircraft. For example, the records management platform 12 may receive historical aircraft records data from a group of users who are utilizing the records management application to manage aircraft records of their aircraft. Additionally, or alternatively, the historical aircraft records data may be provided by a test group of users who have consented to provide historical aircraft records data for purposes of training the data model. The historical aircrafts records data may correspond to the aircraft records data described in connection with FIG. 1B.

In some embodiments, the records management platform 12 may perform one or more preprocessing operations to standardize the historical data into a uniform data type, data format, etc. That is to say, historical data may be received in different data types, different data formats, etc., and the records management platform 12 may standardize this data into a uniform data type, data format, etc. Additionally, or alternatively, the records management platform 12 may perform one or more other preprocessing operations, such as correct missing values, encoding categorical variables (e.g., component name, manufacturer, facility, etc.), scaling numerical features, and/or the like.

As shown by reference number 72, the records management platform 12 may use machine learning to train a data model to make predictions relating to aircraft maintenance and/or recordkeeping. The data model may be trained to identify trends in the aircrafts records data for an aircraft, and to use those trends to make predictions, such as a prediction on the expected service limit and/or failure rate of components and/or parts of the aircraft, a prediction on the estimated time to complete certain maintenance tasks, a prediction of expected maintenance costs for upcoming maintenance, and/or any other prediction related to aircraft maintenance and recordkeeping.

In some embodiments, the records management platform 12 may identify a set of features to use to train the data model. The set of features may include features for historical data values, features for aggregated historical data values, features for combinations of historical data values, features for benchmarks of one or more of these values, features for relationships between two or more of these values, and/or the like.

To predict the expected service limit and/or failure rate of a component of an aircraft, the feature set may include a feature identifying a name of a component, features identifying a part included within that component, a feature identifying a manufacturer of the component, a feature identifying a facility at which a component was created, a feature identifying a facility at which maintenance was performed on a component, a feature identifying a date on which the component was installed, a feature identifying a date on which a component had maintenance performed, a feature identifying a service limit for a component, a feature indicating an average service limit for a component, a feature indicating a reported weather condition for a flight, and/or the like. To predict the estimated time to complete maintenance tasks, the feature set may include a feature identifying a maintenance task, a feature identifying a location at which the maintenance task was performed, a feature identifying an organization that performed the maintenance task, a feature identifying a date on which the maintenance was performed, a feature indicating a time to complete a maintenance task, a feature indicating an average time to complete a maintenance task (e.g., at a given location, or for maintenance tasks performed by the same organization), a feature indicating whether the maintenance task was performed on time or experienced delays, a feature indicating a degree to which the maintenance task was performed on time or experienced delays, and/or the like. To predict expected upcoming maintenance costs, the feature set may include a feature identifying a cost of performing a maintenance task, a feature identifying an average cost of performing the maintenance ask, a feature identifying a change in the cost over a time interval, and/or the like.

The feature set may be identified using one or more feature identification techniques, such as a text mining and latent semantic analysis (LSA) technique, a trend variable analysis technique, an interest diversity analysis technique, a neural networking technique, a composite indicators analysis technique, a clustering analysis technique, and/or the like. That is to say, the records management platform 12 may analyze the historical data using the one or more feature identification techniques, and the output of applying these techniques will be the feature set.

In some embodiments, the records management platform 12 may select a subset of the identified feature set for training the data model. The subset of identified features may be selected using one or more feature selection techniques, which may include one or more filtering techniques, one or more wrapper techniques, one or more embedded techniques, and/or the like. The one or more filtering techniques may be used to remove duplicate, redundant features. These techniques may include a chi-square test, a correlation coefficient, a variance threshold, and/or the like. The one or more wrapper techniques may involve an iterative approach to feature selection (and/or reduction), and may include a forward selection technique, a backward elimination technique, a bi-directional elimination technique, an exhaustive selection technique, a recursive elimination technique, and/or the like. The one or more embedded techniques may include a regularization technique, a tree-based selection technique, and/or the like.

In some embodiments, the records management platform 12 may train the data model using the selected features and one or more machine learning techniques. The one or more machine learning techniques may include a classification-driven training technique, a regression-based training technique, an anomaly detection technique, a clustering technique, an ensemble learning technique, a neural network, and/or the like.

In some embodiments, the records management platform 12 may train the data model using a regression technique, such as linear regression, polynomial regression, support vector regression (SVR), random forest regression, and/or the like. To train the data model using linear regression, the records management platform 12 may estimate how changes in the independent variables (e.g., the aircraft records data) influence changes to the dependent variable (e.g., the prediction being made). For example, to train the data model to predict the service limit of a component, the records management platform 12 may provide the historical data as input to the data model. The data model may process the historical data and may generate coefficient values for each feature in the selected feature set.

The coefficient values represent the strength and direction of the relationship between the independent variables and the dependent variables. In the example described above, the coefficient values may represent how each respective aircraft data value increases, or decreases, the likelihood of a component having a particular service limit. For example, the historical aircrafts records data may include a subset of values for an aircraft with a component that regularly missed required maintenance inspections. If this component also has a service limit that is less than an industry average, then the data model may assign a negative coefficient value to the missed inspection value, due to the fact that the missed inspections may have influenced the component having a service limit that is less than the industry average.

As would be understood by one skilled in the art, similar correlations may be drawn from the other features described above. For example, components of an aircraft that frequently flies through harsh weather conditions may be more likely to have a higher failure rate, or shorter service limit, than components of an aircraft that rarely flies through harsh weather conditions.

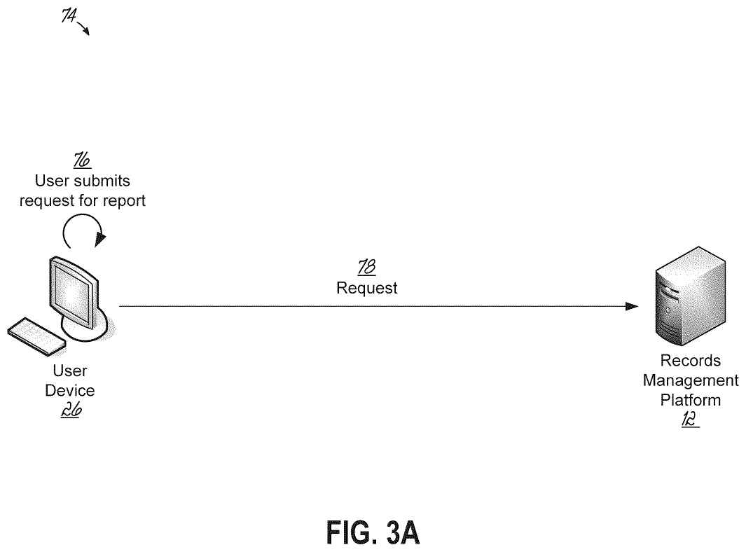

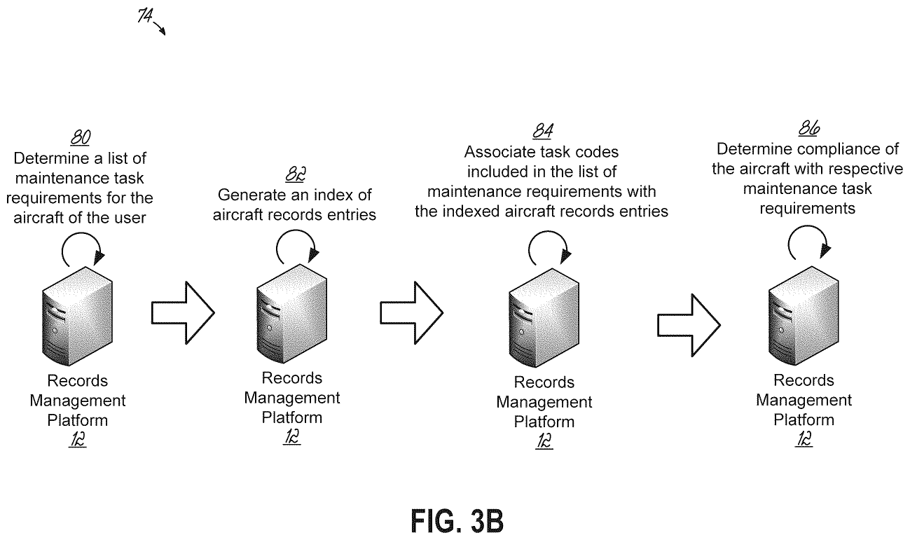

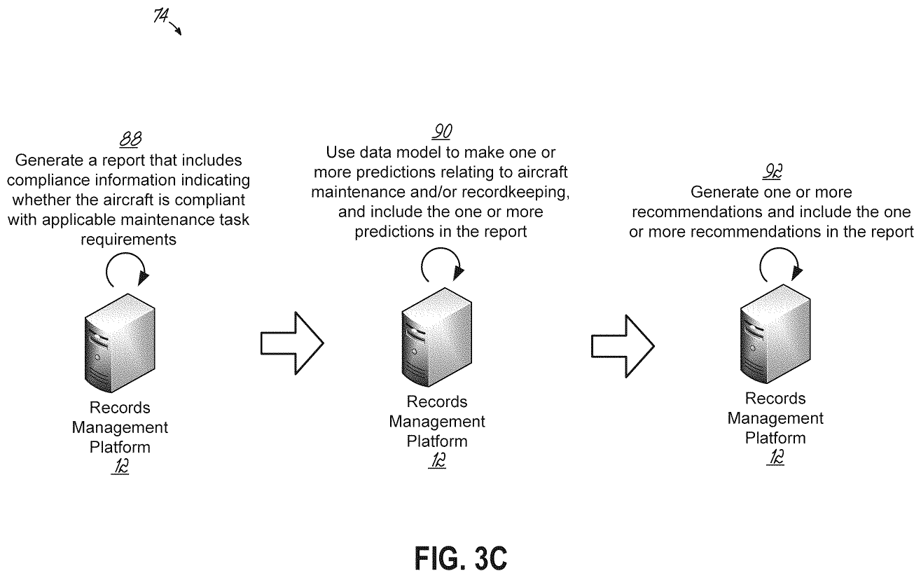

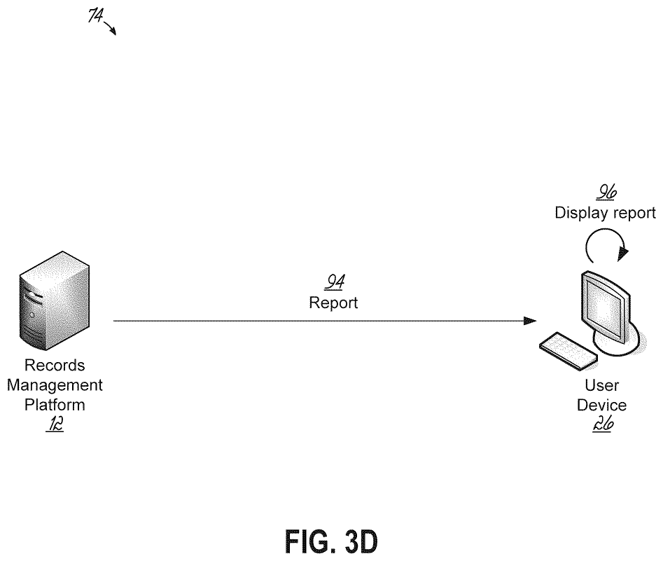

FIGS. 3A-3D are diagrams of an example process 74 for using the trained data model to generate a compliance report includes predictions and recommendations relating to aircraft maintenance and/or recordkeeping. As shown in FIG. 3A, and by reference number 76, a user may interact with a user interface of the aircraft records management application to submit a request for a report. As shown by reference number 78, submitting the request causes the request to be transmitted to the records management platform 12.

As shown in FIG. 3B, and by reference number 80, the records management platform 12 may determine a list of maintenance task requirements for the aircraft of the user. As shown by reference number 80, the records management platform 12 may generate an index of aircraft records entries. As shown by reference number 82, the records management platform 12 may associate task codes included in the list of maintenance requirements with the indexed aircraft records entries. As shown by reference number 86, the records management platform 12 may determine compliance of the aircraft with respective maintenance task requirements. Each of these steps is described in further detail in the description of FIGS. 1D-1G.

As shown in FIG. 3C, and by reference number 88, the records management platform 12 may generate a report that includes compliance information indicating whether the aircraft is compliant with applicable maintenance task requirements. As shown by reference number 90, the records management platform 12 may use the data model to make one or more predictions relating to aircraft maintenance and recordkeeping, and may include the one or more predictions in the report. For example, the records management platform 12 may provide aircraft records data for the user as input to the data model to cause the data model to output the one or more predictions. The one or more predictions may include a prediction on the expected service limit and/or failure rate of components of the aircraft, a prediction on the estimated time to complete maintenance tasks, a prediction on expected upcoming maintenance costs, and/or any other prediction related to aircraft maintenance and record keeping.

In some embodiments, the records management platform 12 may include the one or more predictions in the report. For example, a first portion of the report may include the compliance information indicating whether the aircraft is compliant with various maintenance task requirements, and a second portion of the report may include prediction information indicating the one or more predictions.

As shown by reference number 92, the records management platform 12 may generate one or more recommendations, and may include the one or more recommendations in the report. The one or more recommendations may be generated based on the one or more predictions. For example, a prediction may be made on the expected service limit and/or failure rate of a component, so as to identify pre-mature component failures. In this example, the one or more recommendations may include a recommendation to increase a frequency at which maintenance tasks are performed, a recommendation to schedule performance of a maintenance task within a certain time frame, a recommendation to replace a component within a certain time frame, and/or the like.

To provide another example, a prediction may be made on the estimated time to complete an upcoming maintenance task. In this example, the one or more recommendations may include a recommendation identifying which service provider to use for performing a maintenance task (e.g., so as to reduce downtime or delay), a recommendation identifying a preferred maintenance facility to use for performing the maintenance task, a recommendation that includes an adjustment to a flight schedule to reduce the likelihood that performing the maintenance task results in downtime or a delay, and/or the like.

To provide another example, a prediction may be made on the expected cost of upcoming maintenance to be performed on the aircraft. In this example, the one or more recommendations may include a recommendation that summarizes costs of different service providers, a recommendation identifying a preferred service provider, a recommendation identifying a preferred maintenance facility to use for a service provider, and/or the like.

In some embodiments, the records management platform 12 may include the one or more recommendations in the report. For example, a first portion of the report may include the compliance information indicating whether the aircraft is compliant with various maintenance task requirements, a second portion of the report may include prediction information indicating the one or more predictions, and a third portion of the report may include recommendation information identifying the one or more recommendations.

As shown in in FIG. 3D, and by reference number 94, the records management platform 12 may provide the report to the user device 26. As shown by reference number 96, the user device 26 may display the report via a user interface of the aircraft records management application. For example, the report may be displayed such that the compliance information is visible on a first portion of the user interface, the predictions are visible on a second portion of the user interface, and the recommendations are visible on a third portion of the user interface.

In some embodiments, machine learning may be used to perform one or more autonomous actions. For example, machine learning may be used to generate unique user interface displays on the user device 26, to automatically schedule maintenance inspections, to automatically submit maintenance request forms with third-party maintenance technicians, to send a signal to a controller device that is capable of instructing machine equipment to automatically perform one or more maintenance tasks, and/or the like.

Additionally, or alternatively, machine learning may be used to automatically draft aircraft records entries. For example, assume the aircraft undergoes unscheduled maintenance. In this case, a technician may log into the aircraft records management application using a technician portal and may request the records management platform 12 to generate a logbook entry and/or a work order entry for the maintenance. In this case, the records management platform 12 may automatically populate one or more entries, including an aircraft registration number, make, model number, serial number, time, date, license number of the technician, certified repair station (CRS) number, aircraft cycle count, and/or the like. This reduces the time the technician spends on data entry, and increases the likelihood that the maintenance will be performed in a timely manner.

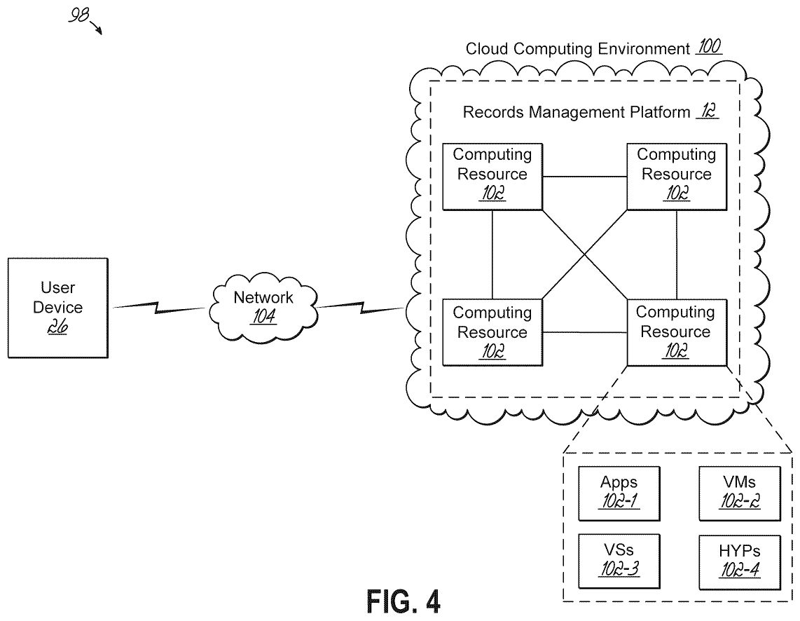

FIG. 4 is a diagram of an example environment 98 in which systems and/or methods described herein may be implemented. As shown in FIG. 4, environment 98 may include a user device 26, a records management platform 12 supported within a cloud computing environment 100, and/or a network 104. Devices of environment 98 may interconnect via wired connections, wireless connections, or a combination of wired and wireless connections.

User device 26 includes one or more devices capable of receiving, generating, storing, processing, and/or providing information associated with aircraft records and/or maintenance. For example, user device 26 may include a device, such as a tablet computer (e.g., an iPad, etc.), a mobile phone (e.g., a smart phone, a radiotelephone, etc.), a laptop computer, a handheld computer, a server computer, a gaming device, a wearable communication device (e.g., a smart wristwatch, a pair of smart eyeglasses, etc.), or a similar type of device.

In some embodiments, the user device 26 may communicate with the records management platform 12 using a communication interface. In some embodiments, the user device 26 may submit a request to the records management platform 12. For example, the user device 26 may submit a request for a research report relating to original equipment manufacturer (OEM) requirements, a report relating to airworthiness directives (ADs), a report relating to modifications and repair requirements for the aircraft, a report detailing any compliance issues of an aircraft and corresponding proposed solutions to those compliance issues, a report identifying an appropriate work scope, and/or any other type of report described herein. In some embodiments, to assist the records management platform 12 in satisfying the request, the user device 26 may provide the records management platform 12 with historical maintenance data for the aircraft, such as logbooks data, work order packages data, modification and repair data, and/or the like.

Records management platform 12 includes one or more devices capable of receiving, storing, processing, and/or providing information associated with aircraft records and/or maintenance. For example, records management platform 12 may include a server device (e.g., a host server, a web server, an application server, etc.), a data center device, or a similar device.

In some embodiments, the records management platform 12 may have access to a database and/or data structure used to sort, organize, and filter one or more types of data described herein. In some embodiments, the database and/or data structure may be local to the records management platform 12. In some embodiments, the database and/or data structure may be a third-party storage provider.

In some embodiments, the records management platform 12 may train a data model using machine learning. The data model may be used to make predictions and/or recommendations in accordance with the principles of the present disclosure. In some embodiments, the data model may be trained by an external device or server and the trained data model may be provided to or made accessible to the records management platform 12.

In some embodiments, as shown, the records management platform 12 may be hosted in the cloud computing environment 100. Notably, while embodiments described herein describe the records management platform 12 as being hosted in the cloud computing environment 100, in some embodiments, the records management platform 12 may not be cloud-based (i.e., may be implemented outside of a cloud computing environment) or may be partially cloud-based.

Cloud computing environment 100 includes an environment that hosts records management platform 12. Cloud computing environment 100 may provide computation, software, data access, storage, etc. services that do not require end-user knowledge of a physical location and configuration of system(s) and/or device(s) that hosts the records management platform 12. As shown, the cloud computing environment 100 may include a group of computing resources 102 (referred to collectively as “computing resources 102” and individually as “computing resource 102”).

Computing resource 102 includes one or more personal computers, workstation computers, server devices, or another type of computation and/or communication device. In some embodiments, the computing resource 102 may host the records management platform 12. The cloud resources may include compute instances executing in the computing resource 102, storage devices provided in the computing resource 102, data transfer devices provided by the computing resource 102, and/or the like. In some embodiments, the computing resource 102 may communicate with other computing resources 102 via wired connections, wireless connections, or a combination of wired and wireless connections.

As further shown in FIG. 4, computing resource 102 may include a group of cloud resources, such as one or more applications (“APPs”) 102-1, one or more virtual machines (“VMs”) 102-2, virtualized storage (“VSs”) 102-3, one or more hypervisors (“HYPs”) 102-4, and/or the like.

Application 102-1 may include one or more software applications that may be provided to or accessed by user device 26. Application 102-1 may eliminate a need to install and execute the software applications on these devices. In some embodiments, one application 102-1 may send/receive information to/from one or more other applications 102-1, via virtual machine 102-2. In some embodiments, application 102-1 may be an aircraft records management application. In some embodiments, the aircraft records management application may include one or more user interfaces that are accessible by users such as aircraft owners and other authorized users, such as an employee of an aircraft management company.

Virtual machine 102-2 may include a software implementation of a machine (e.g., a computer) that executes programs like a physical machine. Virtual machine 102-2 may be either a system virtual machine or a process virtual machine, depending upon use and degree of correspondence to any real machine by virtual machine 102-2. A system virtual machine may provide a complete system platform that supports execution of a complete operating system (“OS”). A process virtual machine may execute a single program and may support a single process. In some embodiments, virtual machine 102-2 may execute on behalf of another device (e.g., user device 26), and may manage infrastructure of the cloud computing environment 100, such as data management, synchronization, or long-duration data transfers.

Virtualized storage 102-3 may include one or more storage systems and/or one or more devices that use virtualization techniques within the storage systems or devices of the computing resource 102. In some embodiments, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 102-4 may provide hardware virtualization techniques that allow multiple operating systems (e.g., “guest operating systems”) to execute concurrently on a host computer, such as computing resource 102. Hypervisor 102-4 may present a virtual operating platform to the guest operating systems and may manage the execution of the guest operating systems.

Network 104 includes one or more wired and/or wireless networks. For example, network 104 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 98 may perform one or more functions described as being performed by another set of devices of environment 98.

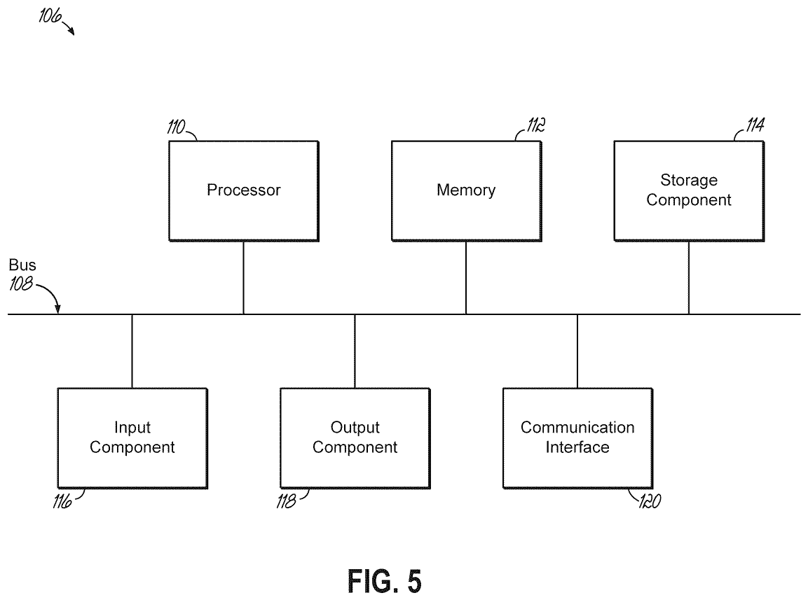

FIG. 5 is a diagram of example components of a device 106. Device 106 may correspond to the user device 26 and/or the records management platform 12. In some embodiments, the user device 26 and/or the records management platform 12 may include one or more devices 106 and/or one or more components of device 106. As shown in FIG. 5, device 106 may include a bus 108, a processor 110, a memory 112, a storage component 114, an input component 116, an output component 118, and/or a communication interface 120.

Bus 108 includes a component that permits communication among multiple components of device 106. Processor 110 is implemented in hardware, firmware, and/or a combination of hardware and software. Processor 110 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing component. In some embodiments, processor 110 includes one or more processors capable of being programmed to perform a function. Memory 112 includes a random-access memory (RAM), a read only memory (ROM), and/or another type of dynamic or static storage device (e.g., a flash memory, a magnetic memory, and/or an optical memory) that stores information and/or instructions for use by processor 110.

Storage component 114 stores information and/or software related to the operation and use of device 106. For example, storage component 114 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 116 includes a component that permits device 106 to receive information, such as via user input (e.g., a touch screen display, a keyboard, a keypad, a mouse, a button, a switch, and/or a microphone). Additionally, or alternatively, input component 116 may include a sensor for sensing information (e.g., a global positioning system (GPS) component, an accelerometer, a gyroscope, and/or an actuator). Output component 118 includes a component that provides output information from device 106 (e.g., a display, a speaker, and/or one or more light-emitting diodes (LEDs)).

Communication interface 120 includes a transceiver-like component (e.g., a transceiver and/or a separate receiver and transmitter) that enables device 106 to communicate with other devices, such as via a wired connection, a wireless connection, or a combination of wired and wireless connections. Communication interface 120 may permit device 106 to receive information from another device and/or provide information to another device. For example, communication interface 120 may include an Ethernet interface, an optical interface, a coaxial interface, an infrared interface, a radio frequency (RF) interface, a universal serial bus (USB) interface, a Wi-Fi interface, a cellular network interface, an application programming interface (API), and/or the like.

Device 106 may perform one or more processes described herein. Device 106 may perform these processes based on processor 110 executing software instructions stored by a non-transitory computer-readable medium, such as memory 112 and/or storage component 114. A computer-readable medium is defined herein as a non-transitory memory device. A memory device includes memory space within a single physical storage device or memory space spread across multiple physical storage devices.

Software instructions may be read into memory 112 and/or storage component 114 from another computer-readable medium or from another device via communication interface 120. When executed, software instructions stored in memory 112 and/or storage component 114 may cause processor 110 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 5 are provided as an example. In practice, device 106 may include additional components, fewer components, different components, or differently arranged components than those shown in FIG. 5. Additionally, or alternatively, a set of components (e.g., one or more components) of device 106 may perform one or more functions described as being performed by another set of components of device 106.

FIGS. 6-9 are diagrams of one or more example processes for performing aircraft records management services in accordance with the principles of the present disclosure. For example, one or more processes shown in FIG. 6 assist with creating a uniform dataset, such as by filtering data, identifying duplicative data, and identifying data that is missing from one or more data sources.

Some embodiments described herein refer to one or more compliance rules that are used to determine whether an aircraft is compliant with maintenance task requirements. One or more of the decision trees described in reference to FIGS. 6-9 include examples of those compliance rules.

As shown in FIG. 6A, and by reference number 122 the records management platform 12 may store aircraft maintenance task data for an aircraft type and for an engine type using AF_Tasks tables and ENG_Tasks tables. As shown by reference number 124, the records management platform 12 may associate values in each respective table with an OEM_Task identifier, such that the lists collectively represent a list of OEM tasks.

As shown by reference number 126, the records management platform 12 may filter the lists based on answers provided by the user. As shown by reference number 128, the records management platform 12 may duplicate tasks, such as tasks relevant to loose equipment items, based on the quantity entered by the user. That is to say, there may be multiple occurrences of the same task requirement based on the number of units installed, and the records management platform 12 may duplicate repeated tasks. As shown by reference number 130, the records management platform 12 may store the resulting list (shown as “OEM_Task_Reqs), which may be referred to hereafter as the OEM list.

As shown by reference number 132, a user may interact with a user interface of the user device 26 to select an online tracking program to use. An online tracking program is a third party program that tracks certain types of aircraft records, and provides services focusing on preventative maintenance, regulation inspection, and prompt correction of defects or discrepancies found during these inspections. As shown by reference number 134, the records management platform 12 determines whether a continuous airworthiness maintenance program (CAMP) is selected. If CAMP is not selected, and as is shown by reference number 136, the records management platform 12 determines whether a different online tracking program is selected, such as an AvTrak program. If AvTrak is not selected, and as is shown by reference number 138, the records management platform 12 determines whether a different online tracking program is selected, such as a Traxxall program. If Traxxall is not selected, and as is shown by reference number 140, the records management platform 12 determines that the aircraft does not utilize a standard reporting system.

If one of the online maintenance programs is selected, as is shown by reference number 142, the records management platform 12 may use textraction or a similar technique to obtain data (e.g., maintenance task data, maintenance task requirements data, etc.), that is to be stored using an online tracking program (OL_TrkRep) table. As shown by reference number 144, the records management platform 12 may filter the obtained data to remove one or more maintenance tasks that do not have an inspection interval and therefore are not required for compliance.

In the example below, the user selects a CAMP. In other examples, a different online maintenance tracking program may be selected. As shown by reference number 146, the records management platform 12 may store the resulting list (shown as “CAMP_Task_Reqs”). The resulting list may be referred to hereafter as a CAMP list. As shown by reference number 148, the records management platform 12 may compare the CAMP list (CAMP_Task_Reqs) and the OEM list (OEM_Task_Reqs).

As shown in FIG. 6B, and by reference number 150, the records management platform 12 may determine whether there are maintenance task codes on the OEM list that do not exist on the CAMP list. If there are maintenance task codes on the OEM list do not exist on the CAMP list, as is shown by reference number 152, the records management platform 12 may flag the maintenance task codes for review. The purpose will be to determine if a matching maintenance task can be found in the CAMP list. As shown by reference number 154, the records management platform 12 may determine whether there are OEM codes that do not correlate to a CAMP task.

If the answer provided in connection with reference number 150 is no, as is shown by reference number 156, the records management platform 12 may determine whether there are maintenance task codes in the CAMP list that do not exist on the OEM list. If all of the maintenance task codes in the CAMP list exist on the OEM list, as is shown by reference number 158, the records management platform 12 may determine whether the maintenance task is due based on a current date, time, and/or cycle count. If the maintenance task is based on the current date, time, and/or cycle count, then, as shown by reference number 160, the records management platform 12 may search lookbook entries for each respective maintenance task code, Referring back to reference number 156, if there are maintenance task codes on the CAMP list that are not on the OEM list, then, as is shown by reference number 162, the records management platform 12 may flag the maintenance task code for review. This may be done to determine if a similar maintenance task can be found in the OEM list. Referring back to reference number 158, if the task is found to be due based on the current date/time/cycle, then, as is shown by reference number 164, the records management platform 12 may determine whether the CAMP list indicates prior compliance. If the CAMP list is not indicative of prior compliance, the records management platform 12 may add the maintenance task code (and/or related data) to a summary report for the user. If the CAMP list is indicative of prior compliance, the records management platform 12 may search through the lookbook entries for each respective maintenance task code.

As is shown by reference number 166, in response to flagging the maintenance task code for review (reference number 162), the records management platform 12 may determine whether there are CAMP codes that do not correlate to any OEM task. As is shown by reference number 168, if the answer to this question is yes, the records management platform 12 may hold the maintenance task code for further review against ICA tasks, AD tasks, and REO tasks. If the answer to this question is no, and as shown by reference number 172, the records management platform 12 may pair maintenance task codes capable of being matched and may use the CAMP code to search the logbooks entries.

If the CAMP list is not indicative of prior compliance, as is shown by reference number 170, the records management platform 12 may add the maintenance task to the summary report for the user.

As shown by reference number 174, if there are OEM maintenance task codes that do not correlate to a CAMP task, the records management platform 12 may determine whether the task is due based on a current date, time, and/or cycle.

As shown by reference number 176, if the maintenance task is not due, the records management platform 12 adds the maintenance task code and/or related task data to the summary report. If the maintenance task is due, then, as shown by reference number 178, the records management platform 12 may search logbook entries for an OEM maintenance task code.

As shown in FIG. 6C, and by reference number 180, the records management platform 12 may determine whether the maintenance task code is found in the logbook entries. As shown by reference number 182, the records management platform 12 may determine that a maintenance task code A, from document B, is not found in the CAMP list. A review of the records shows no indication of previous compliance. Current proof of compliance or explanation for why the maintenance task is not applicable will be required.

If the maintenance task code is found in the logbook entries, then, as shown by reference number 184, the records management platform 12 may determine whether the maintenance task needs to be scheduled using data other than the date, time, and/or cycle count data of the logbook entry.

As shown by reference number 186, the records management platform 12 may determine that the maintenance task code [A], as required by source document [B], requires supplemental document [C]. The records management platform 12 may further determine that work order (WO) [D] be provided from logbook entry [E] to facilitate further research.

As shown by reference number 188, the records management platform 12 may determine whether the necessary document was found. If the necessary document was found, as is shown by reference number 190, the records management platform 12 may determine whether the maintenance task is current. If the maintenance task is not current, as is shown by reference number 192, the records management platform 12 may determine that maintenance task code [A], as is required by source document [B[ was found compliant on supplemental document [C], despite that compliance with the appropriate maintenance task requirement was not actually provided. Current proof of compliance will be required. If the maintenance task is current, the records management platform may add the maintenance task to a summary report for the user (see reference number 198).

As shown by reference number 194, the records management platform 12 may determine whether the maintenance task is current. If the task is not current, as is shown by reference number 196, the records management platform 12 may determine that maintenance task code [A] from source document [B] is not found in the CAMP list. A review of the records indicates it was last performed on supplemental document [C] at hours [D] and cycles [E]. However, this does not provide compliance within the allowable inspection limits. Current proof of compliance will be required.

As shown by reference number 198, the records management platform 12 may add the maintenance task code and/or related data to the summary report for the user.

As shown in FIG. 6D, and by reference number 200, the records management platform 12 may determine whether the maintenance task code is found in the logbook entries. If the maintenance task code is found in the logbook entries, as shown by reference number 202 the records management platform 12 may determine whether the most recent occurrence matches what is found in the CAMP list. If the most recent occurrence matches what is found in the CAMP list, as is shown by reference number 204, the records management platform 12 may determine whether the maintenance task is current. If the task is current, then the records management platform 12 ma add the maintenance task code and/or related data to the summary report for the client (e.g., reference number 198). If the maintenance task is not current, as shown by reference number 206, the records management platform 12 may determine that maintenance task code [A] as required by source document [B], was found to be compliant in supplemental document [C], despite that compliance is not satisfied. Current proof of compliance will be required.

As shown by reference number 208, the records management platform 12 may determine whether CAMP list reflects a more current indication of compliance than the logbook entry. That is to say, does the CAMP list include a compliance date that is more recent than any of the compliance dates listed in the logbook entries? If the CAMP list does not reflect a more current compliance occurrence than the logbook entry, then, as shown by reference number 210, the records management platform 12 may determine that the CMP list includes an older compliance occurrence than found in the logbook entry. As shown by reference number 212, the records management platform 212 may determine that maintenance task code [A] is found in CAMP list from source document [B]. More current compliance is found in logbook entries on supplemental document [C].

If the CAMP list does reflect the more current compliance occurrence, as shown by reference number 214, the records management platform 212 may flag the maintenance task code for review. The logbook entries need to be further analyzed to determine whether compliance as tracked using the CAMP list can be found.

As shown by reference number 216, the records management platform 212 may determine whether the maintenance task code was found in the document indicated in the CAMP list. If the maintenance task code was not found in the document indicated by the CAMP list, then, as shown by reference number 218, the records management platform 212 may determine that maintenance task code [A] is found in source document [B] of the CAMP list (e.g., a different document in the CAMP list). However, compliance with this maintenance task was not found in source document [B] but rather at supplemental document [C].

If the maintenance task code was found in the document indicated in the CAMP list, then, as shown in FIG. 6C by reference number 220, then the records management platform 12 may determine whether the scheduling of the maintenance task needs to be done using something other than the logbook entry date, time, and/or cycle. If no, the records management platform 12 determines whether the maintenance task is current (reference number 204). If yes, and is shown by reference number 222, the records management platform 12 may determine whether maintenance task code [A], as required by source document [B], requires supplemental document [C]. Please provide work order (WO) [D] from logbook entry (LBEO [E] to facilitate further research.

As shown in FIG. 6D by reference number 224, the records management platform 12 may determine whether the maintenance task is current. If the maintenance task is not current, the records management platform 12 may perform the action(s) described in connection with reference number 192. If the maintenance task is current, the records management platform 12 may perform the action(s) described in connection with reference number 198.

As shown by reference number 226, the records management platform 12 may determine whether the CAMP list indicates prior compliance. If the CAMP list does not indicate prior compliance, then, as shown by reference number 228, the records management platform 12 may determine that compliance with maintenance task code [A], as required by source document [B], is not found in the logbook entries. Current proof compliance will be required.

If the CAMP list does indicate prior compliance, then, as is shown in FIG. 6D by reference number 230, the records management platform 12 may flag the maintenance task code for review. The system may pull compliance information from the CAMP list and may search the logbook for a correlating logbook entry.

As shown by reference number 232, the record management platform 12 may determine whether is a logbook entry matches CMP list tracking. If there is a match, then, as shown by reference number 234, a human may review the logbook entry to determine whether the entry includes any values indicative of compliance.

As shown by reference number 236, the record management platform 12 may determine whether a work order package is necessary for further review. If the work order package is not necessary for further review, then, as shown by reference number 238, the record management platform 12 may determine that maintenance task code [A], as required by source document [B], is tracking as compliant with logbook entry [B: date/time/cycle] per the CAMP list. However, after careful review, compliance with this maintenance task does not appear on this entry nor is compliance found anywhere in the logbooks. Current proof of compliance will be required.

If the work order package is necessary for further review, then, as shown in FIG. 6D, and by reference number 240, the records management platform 12 may determine that maintenance task code [A], as required by source document [B], is not found. Please provide work order [E] from logbook entry [D] to facilitate further research.

As shown by reference number 242, the records management platform 12 may determine whether compliance found in the work order. If compliance is found in the work order, then, as shown by reference number 244, records management platform 12 may determine whether the maintenance task is due based on the current date, time, cycle, etc. If compliance is not found, then, as shown by reference number 246, the records management platform 12 may add the maintenance task to the summary report for the user.

If compliance is found, then, as shown by reference number 248, the records management platform 12 may determine whether the maintenance task is current. If the maintenance task is not current, then, as shown by reference number 250, the records management platform 12 may determine that maintenance task [A], as required by source document [B], is found to be compliant with a corresponding maintenance task requirement in logbook entry [D: date/time/cycle] per the CAMP list. However, after careful review, compliance with this maintenance task does not appear on this entry nor is it found anywhere in the logbooks.

If the maintenance task is current, then, as shown by reference number 252, the records management platform 12 may add the maintenance task data and/or related data to the summary report for the user.

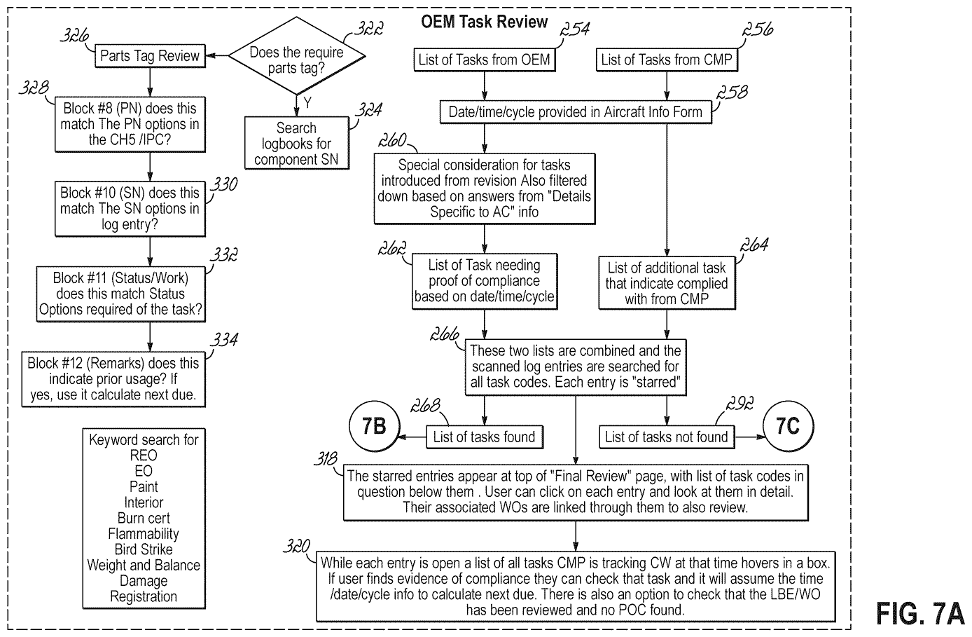

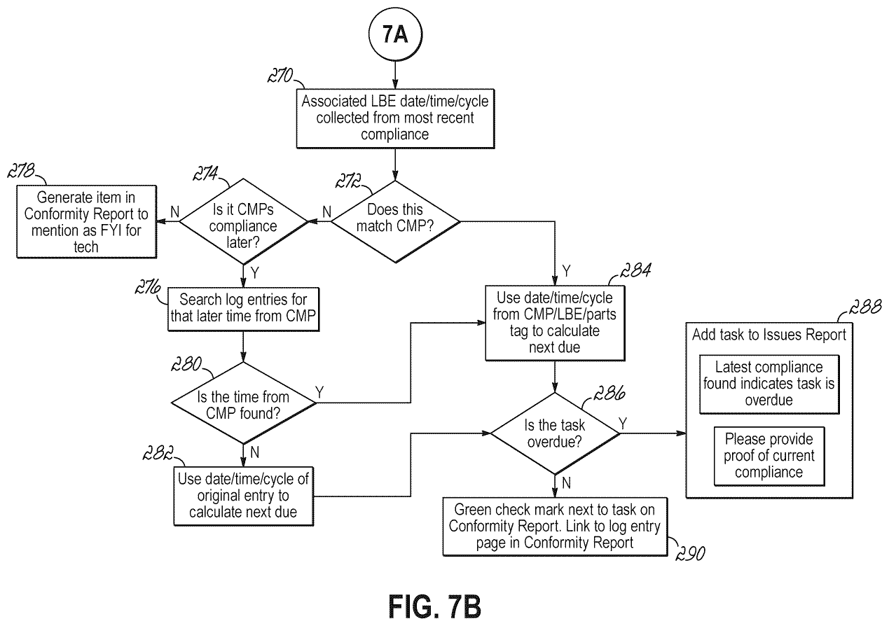

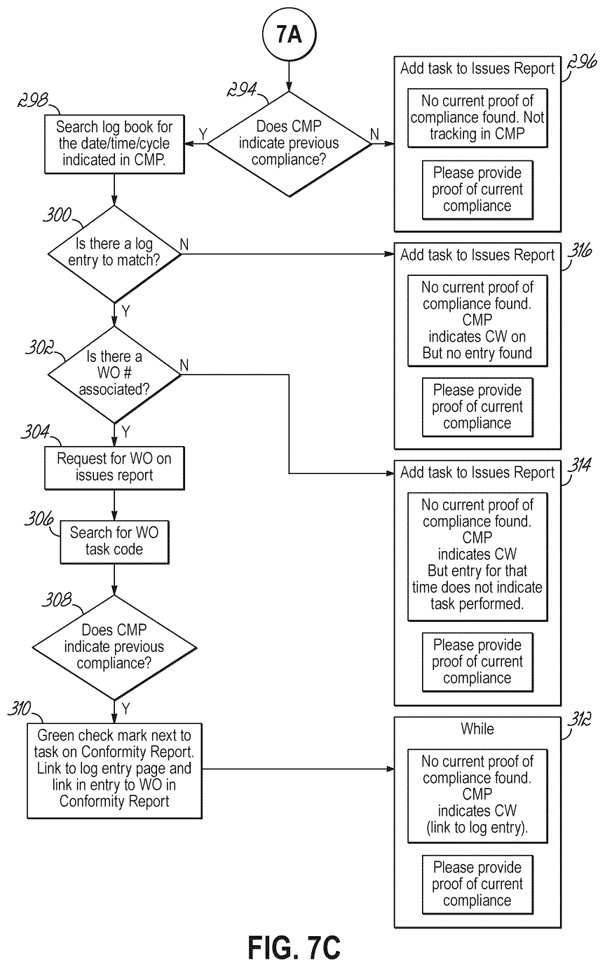

To provide another example, one or more processes shown in FIGS. 7A-7C show specific ways in which compliance information, such as the proof of aircraft compliance, can be tracked, determined, verified, and/or the like. The records management platform 12 may perform one or more of the actions described in connection with reference number 254 through 334.

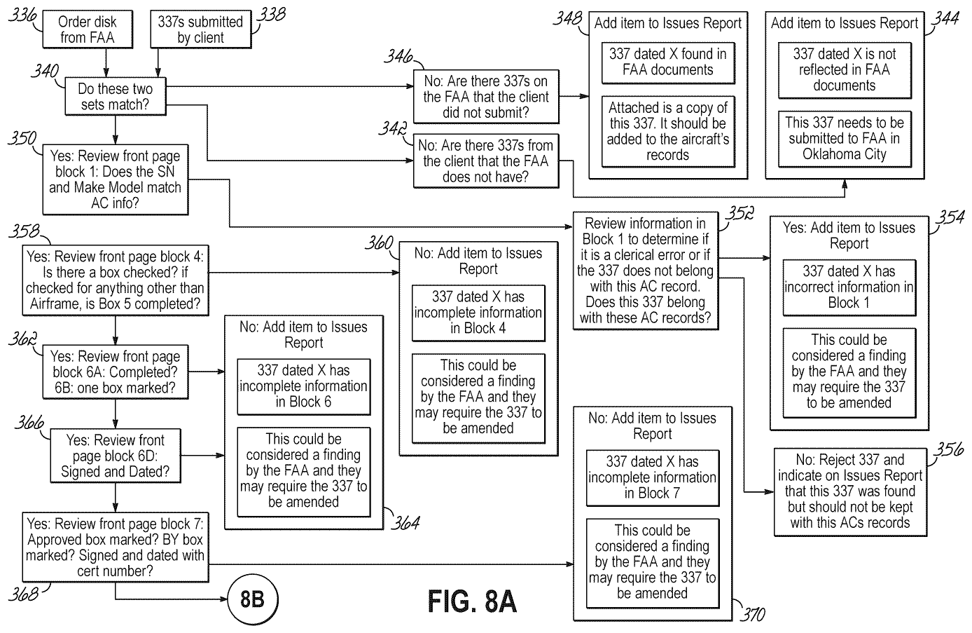

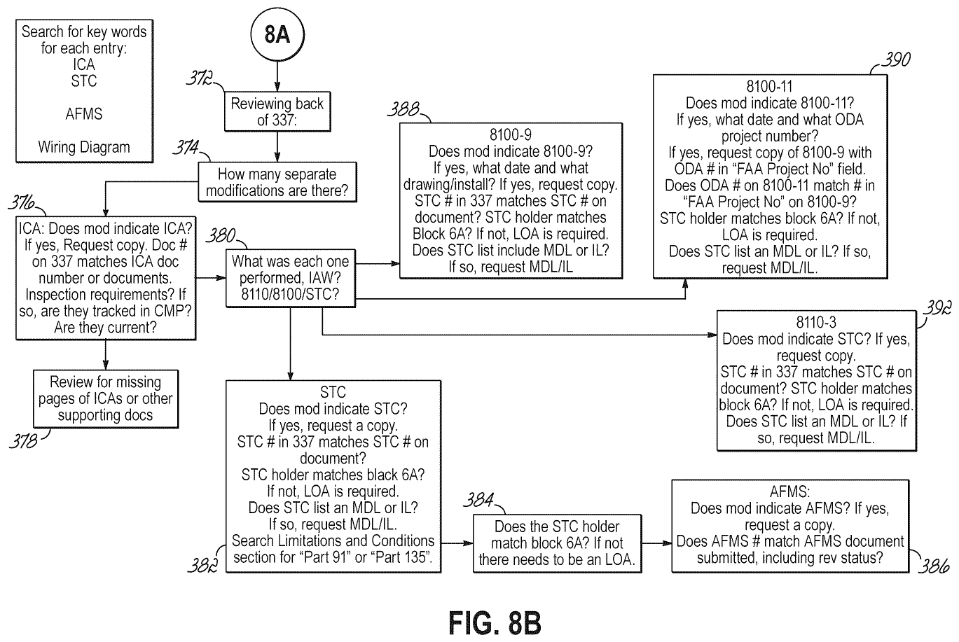

To provide another example, one or more processes shown in FIG. 8 show specific ways in which compliance issued may be identified and/or show one or more proposed solutions to those compliance issues. The records management platform 12 may perform one or more of the actions described in connection with reference numbers 336 through 392.

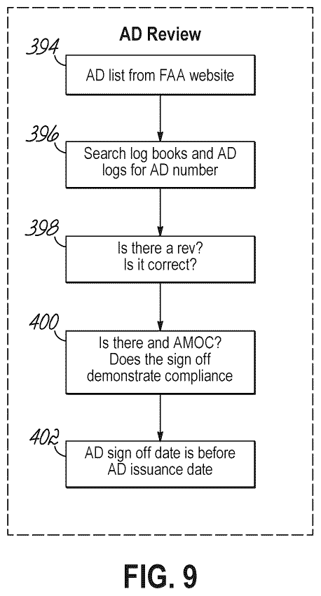

To provide another example, FIG. 9 shows a process for verifying/determining whether an aircraft is compliant with all applicable airworthiness directives. Issues identified by these processes may be included in one or more of the reports that are generated and provided for display on a user interface accessible to the user. In some embodiments, one or more of these issues may be identified using machine learning. For example, a data model may be trained on historical aircraft records data, such that the data model is able to efficiently identify issues or discrepancies and/or is able to predict issues that have yet to occur.

In FIG. 9, as shown by reference number 394, an AD list may be provided to the records management platform 12 from an FAA website. As shown by reference number 396, the records management platform 12 may search logbook entries and AD entries for an AD number. As shown by reference number 398, the records management platform 12 may determine whether a revision number is present and whether the revision number is correct. As shown by reference number 400, the records management platform 12 may determine whether the sign-off demonstrates compliance. As shown by reference number 402, the records management platform 12 may determine that the AD sign-off date is before an AD issuance date.

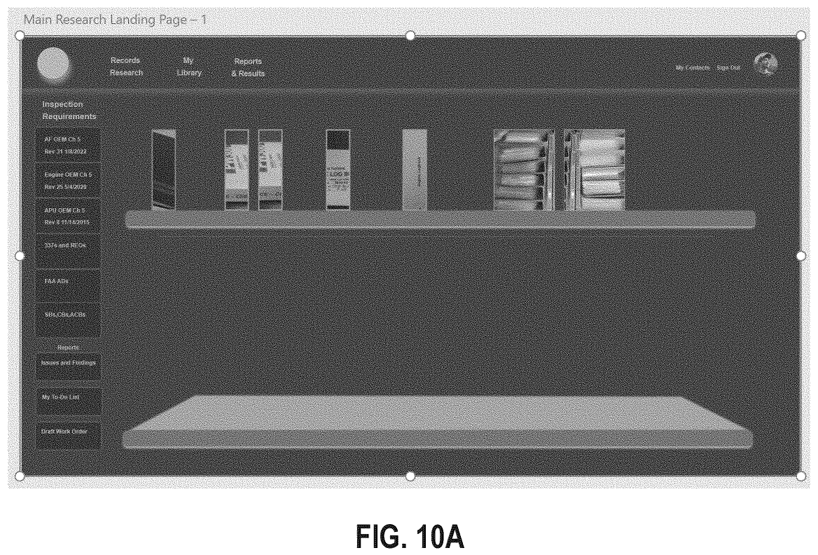

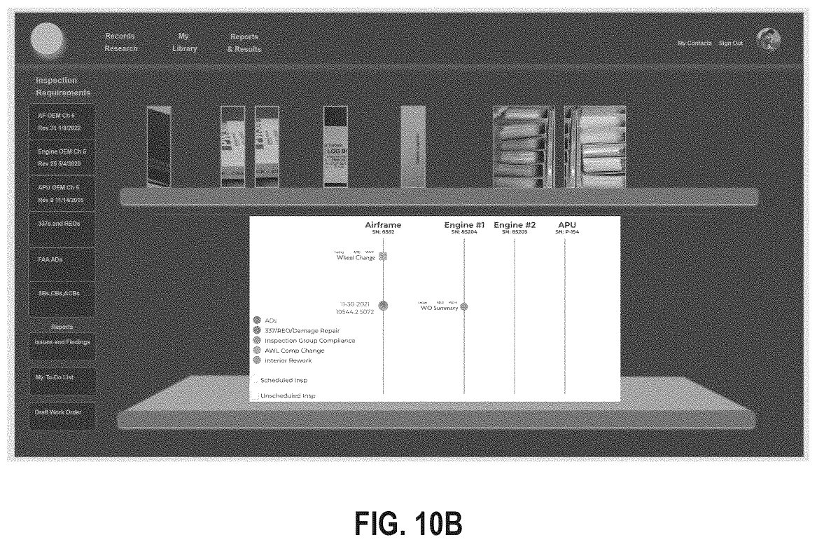

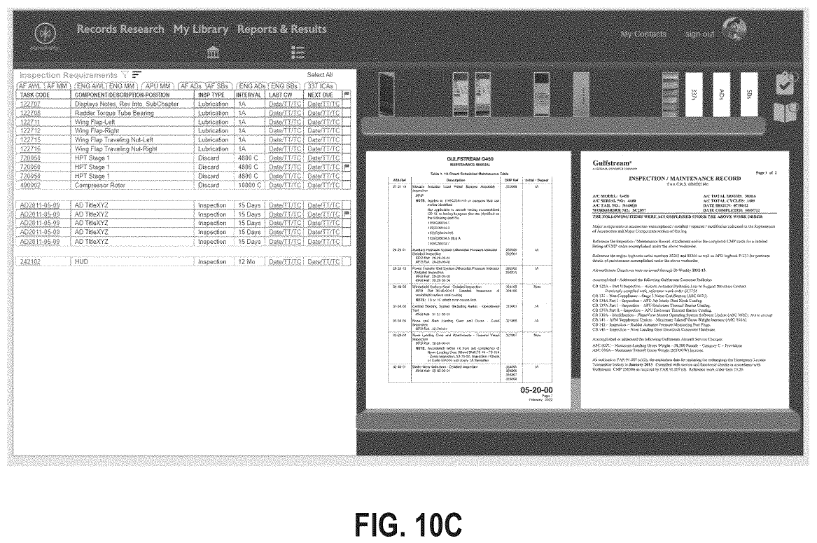

FIGS. 10A-10C are diagrams of example user interfaces of the aircraft records management application. These user interfaces may be displayed on the user device 26 after a user has logged into a registered account.

FIG. 10A is a diagram of a library view of the aircraft records management application. As can be seen in FIG. 10A, a book shelf display includes a top shelf which is shown as having a set of virtual books that represent the aircraft records of an aircraft.

The left side of the user interface includes maintenance requirements icons (shown as inspection requirements icons) and reports icons. The example maintenance requirements shown as icons include an icon for the Airframe (AF) original equipment manufacturer (OEM) Chapter 5 Revision Number 31(1/8/122 ), an icon for the Engine OEM Chapter 5 Revision Number 25 (5/4/120), an icon for the auxiliary power unit (APU) OEM Chapter 5 Revision Number 8 (11/14/2015), an icon for a form involving repairs or alterations that affect the airworthiness of an aircraft (e.g., a form 337, a repair evaluation order (REO), etc.), an icon for Federal Aviation Administration (FAA) airworthiness directives (ADs), and an icon for service bulletins (SBs), customer bulletins (CBs), and/or alert customer bulletins (ACBs). The reports shown include an issues and findings report, a to-do-list report, and a draft work order report. As can be appreciated, other types of requirements and/or reports may be generated and displayed in accordance with the principles of the present disclosure.

FIG. 10B is a diagram of an example user interface of the library view that includes a timeline of events for items selected from a virtual shelf. For example, as can be seen in FIG. 10B, when a user selects one or more of the virtual books displayed on the top shelf of the user interface, the user interface can update to display a timeline of entries associated with each selected entry. Each entry displayed includes a summary card indicating the time and/or date of each event. In the example shown, the summary card for an airframe of the aircraft indicates that a wheel change was performed on 11-30-121. While the drawings provided are shown in black and white, it is to be understood that the summary card can, in some embodiments, be color coded, thereby further improving the quality of the information displayed to the user. For example, the summary card may be color-coded such that information on the card is color coded. To provide a specific example, different colors may be used for each of the information displayed in FIG. 10B, including the information identified in ADs, information included in forms involving repairs or alterations that affect the airworthiness of the aircraft (e.g., 337/REO/damage repairs), information relating to inspection group compliance, information identifying any changes in aircraft weight and compliance logs (AWL), information describing any interior rework performed on the aircraft, and/or any other relevant information. Furthermore, the summary card may display scheduled inspections and unscheduled inspections, alerting the user to whether there are any immediate action items that need to be addressed.

Selecting a summary card can cause the summary card to flip 180 degrees such that the backside of the summary card is visible on the user interface. The backside of the summary card can show additional relevant information. Double clicking on the summary card can cause the user interface to update to display the specific page of a virtual logbook that contains that entry. This interface simulates a physical logbook, where the user is able to “flip” the pages to view different pages and/or entries. The virtual logbook may be displayed on one of the shelves shown in FIG. 10B or may take the user to a separate viewing page.

FIG. 10C is a diagram of an example user interface of the library view that includes a detailed view of one or more maintenance requirements (shown as inspection requirements) for an aircraft. For example, a user may select a maintenance requirements icon from the left side of the user interface. This may cause the user interface to update to display the corresponding maintenance requirements. In the example shown in FIG. 10C, the maintenance requirements document includes a list of relevant task codes. Each task code field is shown in association with a component/description/position field, an inspection type field, an interval field, a last compliance date (CW) field, and an upcoming compliance due date field. If the user selects one of the task codes (e.g., which are provided as hyperlinks), the user interface may update to display the source document that issues the maintenance requirement. Selecting a “last CW” entry may cause the user interface to update to display the “leg” entry which includes the compliance with that requirement.

As used herein, the term “aircraft” is to refer to any vehicle capable of flying.

While one or more embodiments described herein are directed to aircraft records, it is to be understood that this is provided by way of example. In practice, one or more aspects of this disclosure may be applied to other types of records, such as records of land transportation vehicles, watercrafts, and/or any other vehicle, device, object, or article that may leave a lengthy paper trail.

The foregoing disclosure provides illustration and description but is not intended to be exhaustive or to limit the embodiments to the precise form disclosed. Modifications and variations may be made in light of the above disclosure or may be acquired from practice of the embodiments.

Certain user interfaces have been described herein and/or shown in the figures. A user interface may include a graphical user interface, a non-graphical user interface, a text-based user interface, etc. A user interface may provide information for display. In some embodiments, a user may interact with the information, such as by providing input via an input component of a device that provides the user interface for display. In some embodiments, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, and/or a combination of hardware and software. The actual specialized control hardware or software code used to implement these systems and/or methods is not limiting of the embodiments. Thus, the operation and behavior of the systems and/or methods were described herein without reference to specific software code it being understood that software and hardware can be used to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for managing compliance of an aircraft with a set of maintenance task requirements, comprising:
receiving, by a server device, aircraft records data for a set of aircraft records of the aircraft;
receiving, by the server device, a request for a report providing compliance information for the aircraft, the request including identification information for the aircraft;
determining, by the server device, the set of maintenance task requirements for the aircraft by using the identification information for the aircraft to search a data structure that associates identification information for respective aircraft included in a group of aircraft with sets of maintenance task requirements for the respective aircraft in the group;
identifying, by the server device, aircraft records entries, of the set of aircraft records, that are to be used as compliance values for respective maintenance task requirements included in the set of maintenance task requirements, wherein the aircraft records entries are identified by using search keys to search the aircraft records to identify the aircraft records entries that are relevant to compliance with the respective maintenance task requirements;
determining, by the server device, whether the aircraft complies with the respective maintenance task requirements, wherein compliance is determined based on whether the compliance values satisfy one or more compliance rules;
generating, by the server device, the report providing the compliance information for the aircraft, where the compliance information indicates whether the aircraft complies with the respective maintenance requirements; and
causing, by the server device, the report to be accessible via a user interface of an application used to manage the compliance of the aircraft with the set of maintenance task requirements.

2. The method of claim 1, further comprising:
indexing the aircraft records entries such that respective aircraft records entries are associated with one or more spatial positioning values that identify one or more corresponding locations within the respective aircraft records;
associating maintenance task identifiers included in the maintenance task requirements with aircraft records entries that have been indexed;
generating, for an aircraft records entry, of the aircraft records entries, a link to a location of the aircraft records entry within a particular aircraft record; and
wherein generating the report comprises:
generating the report to include the link such that compliance with a maintenance task requirement corresponding to the aircraft records entry is verifiable by a user.

3. The method of claim 2, further comprising:
receiving instructions from a user device to update the user interface to display the location of the aircraft records entry within the particular aircraft record; and
causing the user interface to display the particular aircraft record such that the location of the aircraft records entry is annotated on the user interface.

4. The method of claim 2, further comprising:
prior to indexing the aircraft records entries, identifying keywords relevant to compliance with the maintenance task requirements; and
wherein indexing the aircraft records entries comprises:
indexing only a portion of the aircraft records entries that correspond to the identified keywords.

5. The method of claim 1, further comprising:
generating, using a data model that has been trained using machine learning, a predicted service limit or failure rate of a component of the aircraft, wherein the prediction is generated by providing the aircraft records data as input to the data model to cause the data model to output the prediction;
generating a recommended action to perform based on the prediction; and
wherein generating the report comprises:
generating the report in a manner that includes the prediction and the recommendation.

6. The method of claim 5, wherein the recommended action includes one or more of:
a recommendation to increase a frequency at which a maintenance task is performed,
a recommendation to schedule performance of the maintenance task within a designated time frame, or
a recommendation to replace the component within a designated time frame.

7. The method of claim 1, further comprising:
generating, using a data model that has been trained using machine learning, an estimated time to complete a maintenance task, wherein the prediction is generated by providing the aircraft records data as input to the data model to cause the data model to output the prediction;
generating a recommended action to perform based on the prediction; and
wherein generating the report comprises:
generating the report in a manner that includes the prediction and the recommendation.

8. The method of claim 7, wherein the recommended action includes one or more of:
a recommendation identifying a service provider to use for performing a maintenance task,
a recommendation identifying a preferred maintenance facility to use when performing the maintenance task, or
a recommended adjustment to a flight schedule to accommodate the estimated time to complete the maintenance task.

9. The method of claim 1, further comprising:
generating, using a data model that has been trained using machine learning, an expected maintenance cost for performing a maintenance task, wherein the prediction is generated by providing the aircraft records data as input to the data model to cause the data model to output the prediction;
generating a recommended action to perform based on the prediction; and
wherein generating the report comprises:
generating the report in a manner that includes the prediction and the recommendation.

10. The method of claim 9, wherein the recommended action includes one or more of:
a recommendation identifying a preferred service provider, or
a recommendation identifying a preferred maintenance facility to use when performing the maintenance task.

11. The method of claim 1, wherein generating the report comprises:
generating, on a first portion of the report, data identifying a compliance status with one or more maintenance task requirements of the set of maintenance task requirements, and
generating, on a second portion of the report, plan data identifying a compliance plan that includes information identifying actions to perform to remain in compliance with the one or more maintenance task requirements.

12. The method of claim 1, wherein generating the report comprises:
generating, on a first portion of the report, error identification information that identifies one or more recording errors found in the aircraft records data, and
generating, on a second portion of the report, information that identifies one or more corrective actions to correct the one or more identified recording errors.

13. The method of claim 1, wherein generating the report comprises:
generating a summary page of the report that includes summary information that summarizes one or more maintenance task requirements, of the set of maintenance task requirements, and other summary information that summarizes compliance with the one or more maintenance task requirements.

14. A device, comprising:
one or more memories; and
one or more processors, communicatively coupled to the one or more memories, to:
receive aircraft records data for a set of aircraft records of the aircraft;
receive a request for a report providing compliance information for the aircraft, the request including identification information for the aircraft;
determine the set of maintenance task requirements for the aircraft by using the identification information for the aircraft to search a data structure that associates identification information for respective aircraft included in a group of aircraft with sets of maintenance task requirements for the respective aircraft in the group;
identify aircraft records entries, of the set of aircraft records, that are to be used as compliance values for respective maintenance task requirements included in the set of maintenance task requirements, wherein the aircraft records entries are identified by using search keys to search the aircraft records to identify the aircraft records entries that are relevant to compliance with the respective maintenance task requirements;
determine whether the aircraft complies with the respective maintenance task requirements, wherein compliance is determined based on whether the compliance values satisfy one or more compliance rules;
generate the report providing the compliance information for the aircraft, where the compliance information indicates whether the aircraft complies with the respective maintenance requirements; and
cause the report to be accessible via a user interface of an application used to manage the compliance of the aircraft with the set of maintenance task requirements.

15. A non-transitory computer-readable medium storing instructions, the instructions comprising:
one or more instructions that, when executed by one or more processors, cause the one or more processors to:
receive aircraft records data for a set of aircraft records of the aircraft;
receive a request for a report providing compliance information for the aircraft, the request including identification information for the aircraft;
determine the set of maintenance task requirements for the aircraft by using the identification information for the aircraft to search a data structure that associates identification information for respective aircraft included in a group of aircraft with sets of maintenance task requirements for the respective aircraft in the group;
identify aircraft records entries, of the set of aircraft records, that are to be used as compliance values for respective maintenance task requirements included in the set of maintenance task requirements, wherein the aircraft records entries are identified by using search keys to search the aircraft records to identify the aircraft records entries that are relevant to compliance with the respective maintenance task requirements;
determine whether the aircraft complies with the respective maintenance task requirements, wherein compliance is determined based on whether the compliance values satisfy one or more compliance rules;
generate the report providing the compliance information for the aircraft, where the compliance information indicates whether the aircraft complies with the respective maintenance requirements; and
cause the report to be accessible via a user interface of an application used to manage the compliance of the aircraft with the set of maintenance task requirements.
